(19) United States
(12) Patent Application Publication
(10) Pub. No.: US 2014/0131442 A1
(43) Pub. Date: May 15, 2014

(54) Mobile Device Card Reader

(71) Applicant: Banc of America Merchant Services, LLC, Charlotte, NC (US)

(72) Inventors: Matthew Morrow, Charlotte, NC (US); Keith Alan Newbrough, Parker, CO (US); Cormac Eubanks, San Francisco, CA (US); Adam Christopher Wrigley, Brooklyn, NY (US); Francois Duc Nguyen, San Francisco, CA (US); Quinn Slater Huffstetler, San Francisco, CA (US)

(73) Assignee: Banc of America Merchant Services, LLC, Charlotte, NC (US)

(21) Appl. No.: 14/066,094

(22) Filed: Oct. 29, 2013

Related U.S. Application Data
(60) Provisional application No. 61/724,630, filed on Nov. 9, 2012.

(51) Int. Cl. G06K 7/01; G06K 7/08; G06K 7/06; G06K 7/00

(52) U.S. Cl. CPC G06K 7/01; G06K 7/0004; G06K 7/082; G06K 7/065
USPC 235/440; 235/439; 235/449; 235/441

(57) ABSTRACT

A card reader for use with a mobile device includes a card reader body having an information reading area configured to receive a card, an information reader configured to read information stored on the card and a connection device disposed on the card reader body and configured to be removably connected to the mobile device. The card reader also includes a first arm extending in the first direction away from the card reader body and spaced apart from the connection device and an opposing second arm extending in the first direction away from the card reader body and spaced apart from the connection device. The first arm and the second arm are configured to contact the mobile device and limit movement of the card reader body with respect to the mobile device when the card reader body is connected to the mobile device via the connection device.

### CROSS-REFERENCE TO RELATED APPLICATIONS

This application claims priority to U.S. provisional application Ser. No. 61/724,630 filed Nov. 9, 2012, which is incorporated herein by reference in its entirety.

### TECHNOLOGY FIELD

The present invention relates generally to a card reader for use with a mobile device, and more particularly to a card reader that limits movement of the card reader with respect to the mobile device when the card reader body is connected to the mobile device.

### BACKGROUND

The point of sale for some vendors may be an ever-moving destination. The limited transaction volume of some vendors, however, may not justify the expense of a mobile payent terminal. Accordingly, vendors without mobile payment terminals may handle credit card information in an inefficient and unsecure manner. For example, some vendors without mobile payment terminals may write down credit card numbers or other private information to be called into credit companies later, exposing customers to potential identity theft. Some vendors may also accept alternative means of payment, such as accepting checks on faith, exposing the vendors to potential loss.

Conventional credit card readers may be coupled to vendors' mobile devices (e.g., smart phone) to provide more secure processing of credit card information at different locations. Some conventional card readers may be both mechanically and electronically coupled to the mobile devices via a connecting device, such as an audio jack. The conventional card readers typically include a slot having a reading element for reading the magnetic stripe of the card. The information on the magnetic stripe may then be sent to the mobile device via the audio jack and then to the credit card company via cellular networks, WWI. Bluetooth or other communication modes.

The configuration of these conventional credit card readers, however, may provide unreliable card reads (e.g. unreadable swipes) and damage to the card readers and/or the mobile devices because the reader may move during the card reading (e.g., swiping) process. A more reliable and secure card reader for a mobile device is needed.

### SUMMARY

Embodiments of the present invention are directed to a card reader for use with a mobile device configured to receive and transmit information. The card reader includes a card reader body, a first arm and an opposing second arm. The card reader body includes an information reading area configured to receive a card, an information reader configured to read information stored on the card and a connection device disposed on the card reader body. The connection device extends in a first direction away from and substantially perpendicular to the card reader body and is configured to be removably connected to the mobile device. The first arm extends in the first direction away from the card reader body and is spaced apart from the connection device. The opposing second arm extends in the first direction away from the card reader body and is spaced apart from the connection device. The first arm and the second arm are configured to contact the mobile device and limit movement of the card reader body with respect to the mobile device when the card reader body is connected to the mobile device via the connection device.

According to one embodiment, the first arm and the second arm are configured to contact opposing surfaces of the mobile device to limit rotational movement of the card reader body about an axis of the connection device when the card reader body is connected to the mobile device via the connection device.

According to an aspect of the embodiment, the card reader body includes a front and an opposing back spaced from the front. The connection device is proximate to the front of the card reader body and the first arm and the second arm are spaced from the connection device and proximate to the back of the card reader body to limit the rotational movement of the card reader body about an axis of the connection device.

According to another embodiment, the first arm and the second arm each further include a guide element disposed on respective arm inner surfaces and proximate to respective distal ends of the arms. Portions of the first arm and the second arm are configured to flex when the guide elements contact the mobile device during installation of the card reader body to the mobile device and removal of the card reader body from the mobile device.

In one aspect of an embodiment, each guide element includes a first tapered surface to facilitate connection of the card reader body to the mobile device.

In another aspect of an embodiment, at least one of the guide elements is configured to be received by a recess on a surface of the mobile device.

In yet another aspect of an embodiment, each guide element includes a second tapered surface to facilitate removal of the at least one guide element from the recess during removal of the card reader body from the mobile device.

According to one embodiment, the information reader is a magnetic card reader.

According to another embodiment, the information reader is an EMV reader.

In one embodiment, the information reading area includes both a magnetic card reader and an EMV reader.

In another embodiment, the information reading area includes a contactless reader.

In yet another embodiment, the card reader further includes another information reading area. Each information reading area includes a different type of reader.

Embodiments of the present invention are directed to a card reader for use with a mobile device configured to receive and transmit information. The card reader includes a card reader body having one or more information reading areas configured to receive a card having card information stored thereon. The card reader also includes one or more connection devices configured to connect the card reader body to the mobile device and transmit the card information to the mobile device. The card reader further includes one or more stability arms coupled to and extending from the card reader body and configured to contact the mobile device and limit movement of the card reader body with respect to the mobile device.

According to one embodiment, the one or more stability arms is configured to limit rotational movement of the card reader body about an axis of the connection device.

According to another embodiment, the one or more stability arms are removably coupled to the card reader body.

According to another embodiment, the one or more stability arms are movable along one or more surfaces of the card reader body.

In yet another embodiment, the one or more stability arms include a pair of opposing stability arms. Each stability arm extends from an opposing side of the card reader body and is configured to contact an opposing side of the mobile device.

In an aspect of an embodiment, the pair of opposing stability arms each include a guide element disposed on respective stability arm inner surfaces. Portions of the opposing stability arms are configured to flex when the guide elements contact the mobile device during installation of the card reader body to the mobile device and removal of the card reader body from the mobile device.

In another aspect of an embodiment, each guide element has a tapered surface to facilitate installation of the card reader body on the mobile device.

In yet another aspect of an embodiment, each guide element has a second tapered surface to facilitate removal of the card reader body from the mobile device.

In yet another aspect of an embodiment, the one or more stability arms include a plurality of stability arms extending from a first side of the card reader body and a plurality of opposing stability arms extending from an opposing side of the card reader body.

According to one embodiment, card readers may include a single stability arm extending from the card reader body.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a perspective view of an exemplary card reader connected to a mobile device for use with embodiments of the present invention;

FIG. 2 illustrates a perspective view of the exemplary card reader shown in FIG. 1 for use with embodiments of the present invention;

FIG. 3 is an exploded view of the exemplary card reader shown in FIG. 1 and a cap for use with embodiments of the present invention;

FIG. 4A through FIG. 4F show respective front, back, first side, second side, top and bottom views of the card reader shown in FIG. 1 for use with embodiments of the present invention;

FIG. 5 is a perspective view of a card reader having different information reading areas for use with embodiments of the present invention;

FIG. 6A and FIG. 6B are front views of an exemplary card reader at different states of installation on a mobile device for use with embodiments of the present invention;

FIG. 7 is a perspective view of an exemplary card having multiple connection points and a detachable connecting device for use with embodiments of the present invention;

FIG. 8 is a perspective view of an exemplary card reader having two opposing pairs of stability arms and a card having a magnetic information stripe for use with embodiments of the present invention;

FIG. 9 is a perspective view of an exemplary card having a magnetic information stripe and an EMV integrated circuit chip for use with embodiments of the present invention;

FIG. 10 is a perspective view of an exemplary card reader having four opposing pairs of stability arms and a card having a magnetic information stripe for use with embodiments of the present invention;

FIG. 11 is a perspective view of an exemplary card reader having a pair of opposing stability elements extending from a front of the card reader body to a back of the card reader body for use with embodiments of the present invention;

FIG. 12 is a perspective view of an exemplary card reader having stability elements forming a channel that houses a connection device for use with embodiments of the present invention;

FIG. 13A through FIG. 13O show perspective views of different card readers configured to be connected to mobile devices for use with embodiments of the present invention;

FIG. 14A through FIG. 14G show a perspective view, front view, back view, top view, bottom view, first side view and second side views, respectively, of an exemplary card reader coupled to a cap for use with embodiments of the present invention;

FIG. 15A through FIG. 15H show a perspective view, front view, back view, top view, bottom view, first side view, second side view and an exploded view, respectively, of the exemplary cap shown in FIG. 14A through FIG. 14G for use with embodiments of the present invention;

FIG. 16 is a partially exploded view of the exemplary card reader and cap shown in FIG. 14A through FIG. 14G for use with embodiments of the present invention;

FIG. 17A are perspective view of an exemplary card reader having a cap for use with embodiments of the present invention;

FIG. 17B is a perspective view of the exemplary card reader shown in FIG. 17A connected to a mobile device for use with embodiments of the present invention;

FIG. 17C is a partially exploded view of the exemplary card reader having the cap shown in FIG. 17A for use with embodiments of the present invention;

FIG. 17D is a perspective view of the exemplary card reader shown in FIG. 17A for use with embodiments of the present invention;

FIG. 18A are perspective view of an exemplary card reader having a cap for use with embodiments of the present invention;

FIG. 18B is a perspective view of the exemplary card reader shown in FIG. 18A connected to a mobile device for use with embodiments of the present invention;

FIG. 18C is a partially exploded view of the exemplary card reader having the cap shown in FIG. 18A for use with embodiments of the present invention;

FIG. 18D is a perspective view of the exemplary card reader shown in FIG. 18A for use with embodiments of the present invention;

FIG. 19A are perspective view of an exemplary card reader having a cap for use with embodiments of the present invention;

FIG. 19B is a perspective view of the exemplary card reader shown in FIG. 19A connected to a mobile device for use with embodiments of the present invention;

FIG. 19C is a partially exploded view of the exemplary card reader having the cap shown in FIG. 19A for use with embodiments of the present invention;

FIG. 19D is a perspective view of the exemplary card reader shown in FIG. 19A for use with embodiments of the present invention;

FIG. 20A are perspective view of an exemplary card reader having a cap for use with embodiments of the present invention;

FIG. 20B is a perspective view of the exemplary card reader shown in FIG. 20A connected to a mobile device for use with embodiments of the present invention;

FIG. 20C is a partially exploded view of the exemplary card reader having the cap shown in FIG. 20A for use with embodiments of the present invention;

FIG. 20D is a perspective view of the exemplary card reader shown in FIG. 20A for use with embodiments of the present invention;

FIG. 21A through 21E are perspective views of exemplary card readers and caps for use with embodiments of the present invention;

FIG. 22 is a perspective view of an exemplary package for housing a card reader for use with embodiments of the present invention;

FIG. 23 is a perspective view of an exemplary package for housing a card reader and a sleeve for use with embodiments of the present invention;

FIG. 24 is a perspective view of an exemplary package for housing a card reader and having a sleeve for use with embodiments of the present invention; and

FIG. 25A through FIG. 32 show exemplary packaging to hold card readers for use with embodiments of the present invention.

### DETAILED DESCRIPTION OF ILLUSTRATED EMBODIMENTS

As described above, instability of conventional card readers may provide unreliable card reads (e.g., unreadable swipes). Also, movement of card readers while swiping cards may cause damage to the card readers and/or the mobile devices. For example, conventional card readers may rotate about an axis of the audio jack with respect to the mobile devices. The rotational movement may affect the reliability of reading of the cards. For example, a user may have trouble lining up the card with the card reader slot for swiping. The rotational movement during a swipe may also cause an inability to read the information on the card. Conventional card readers may also move in other directions with respect to the mobile device, which may damage the connection device, such as the audio jack of the card reader. Further, the location of connection ports (e.g. audio port) on some mobile devices may be different than the location of connection ports on other mobile devices. Accordingly, some card readers may create awkward handling for swiping when coupled to certain mobile devices.

Embodiments of the present invention are directed to an improved mobile device card reader. Embodiments provide an improved card reader that includes stability elements that extend from the card reader and contact the mobile device to limit movement of the card reader with respect to the mobile device when the card reader body is connected to the mobile device. Some embodiments provide opposing stability arms that contact opposing sides of the mobile device to limit rotational movement of the card reader body about an axis of the connection device. Some embodiments utilize guide elements disposed on the stability arms to cause portions of the arms to flex such that the guide elements contact opposing surfaces of the mobile device. Aspects of embodiments provide guide element having tapered surfaces to facilitate installation of the card reader body on mobile devices and removal of the card reader body from the mobile devices.

Embodiments include card readers having information reading areas for receiving cards and reading information stored on a data storage medium of the cards. For example, two suitable data storage mediums include EMV chips and magnetic stripes. In some embodiments, card readers may include separate information reading areas for receiving and reading EMV cards and magnetic stripe cards. In some embodiments, card readers may include a single information reading areas for receiving and reading either EMV cards or magnetic stripe cards. In some embodiments, card readers may include a single information reading area for receiving and reading both EMV cards and magnetic stripe cards.

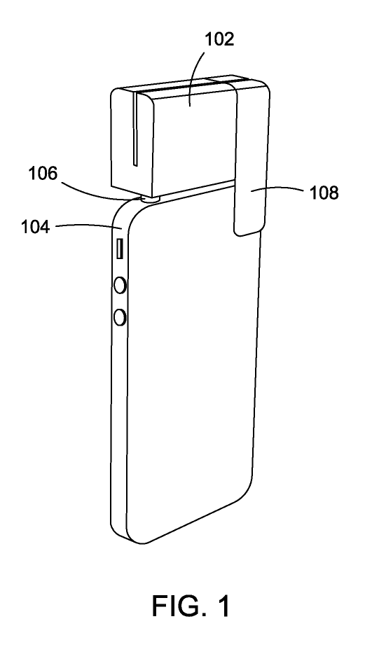

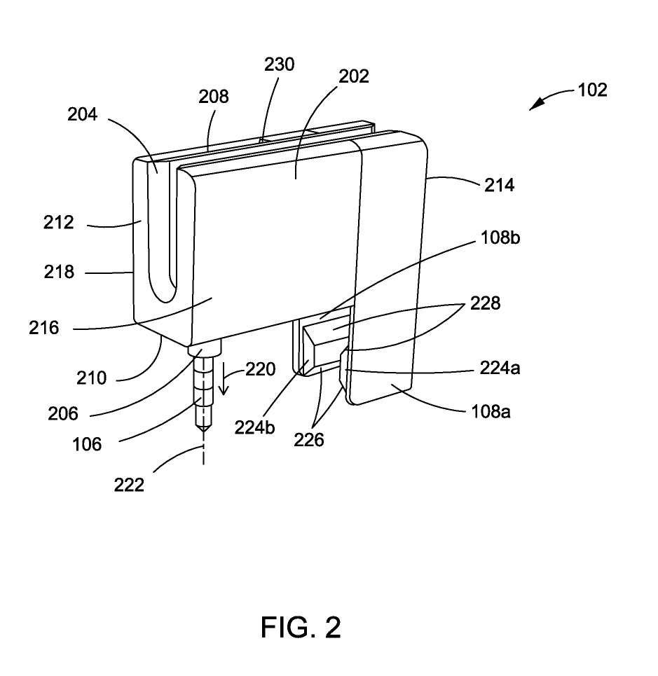

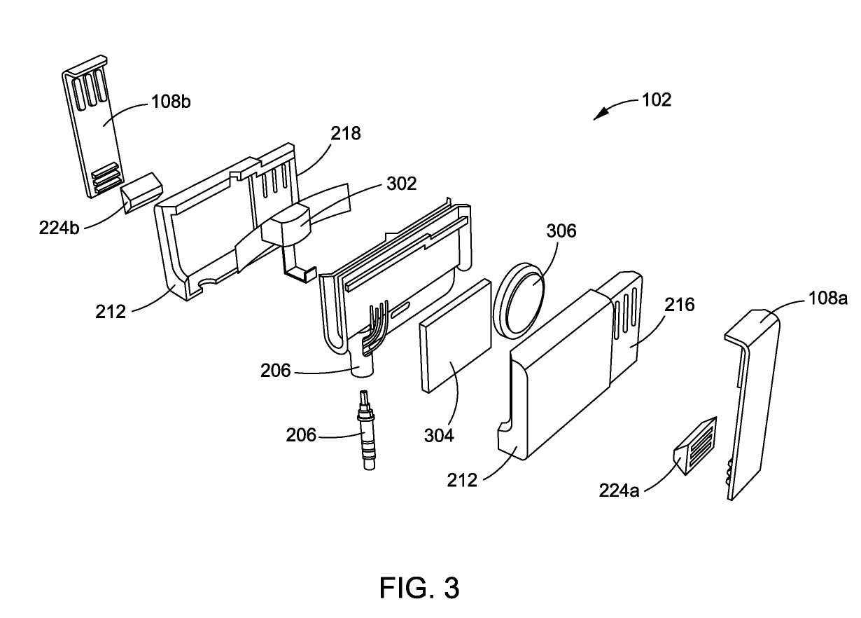

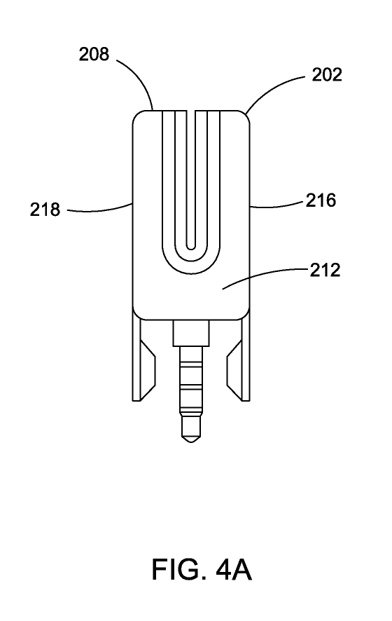

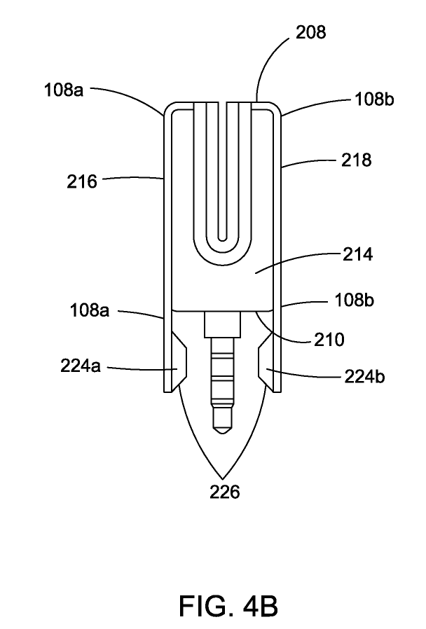

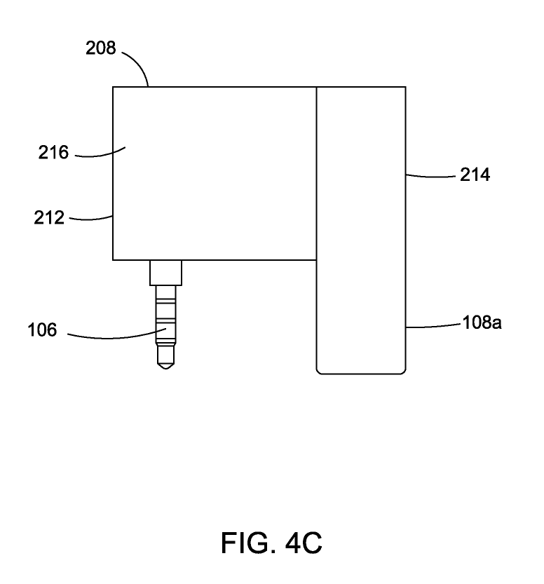

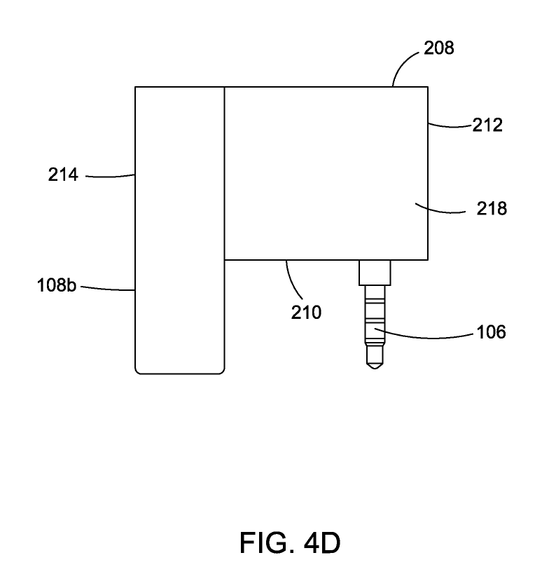

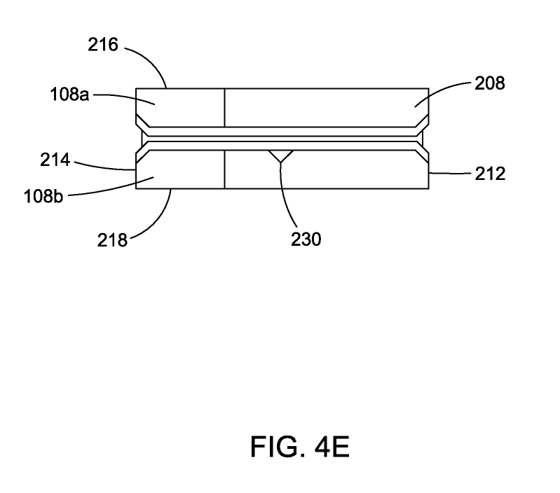

FIG. 1 illustrates a card reader 102 connected to a mobile device 104. FIG. 2 is a perspective view of the exemplary card reader 102 shown in FIG. 1. FIG. 3 is an exploded view of an exemplary card reader shown in FIG. 2. Front view (FIG. 4A), back view (FIG. 4B), first side view (FIG. 4C), second side view (FIG. 4D), top view (FIG. 4E) and bottom view (FIG. 4F) of card reader 102 are shown, respectively, at FIG. 4A through FIG. 4F. The geometries of the card reader 102 and the mobile device 104 shown in FIG. 1 through FIG. 4F are exemplary. Other embodiments may include card readers and mobile devices having geometries different than card reader 102 and the mobile device 104 shown in FIG. 1.

As shown in FIG. 1, card reader 102 may be connected to mobile device 104 via connection device 106. Card reader 102 may also be coupled to the mobile device 104 via stability elements, such as stability arms 108, to limit movement of the card reader 102 with respect to the mobile device 104 when the card reader 102 is connected to the mobile device via connection device 106.

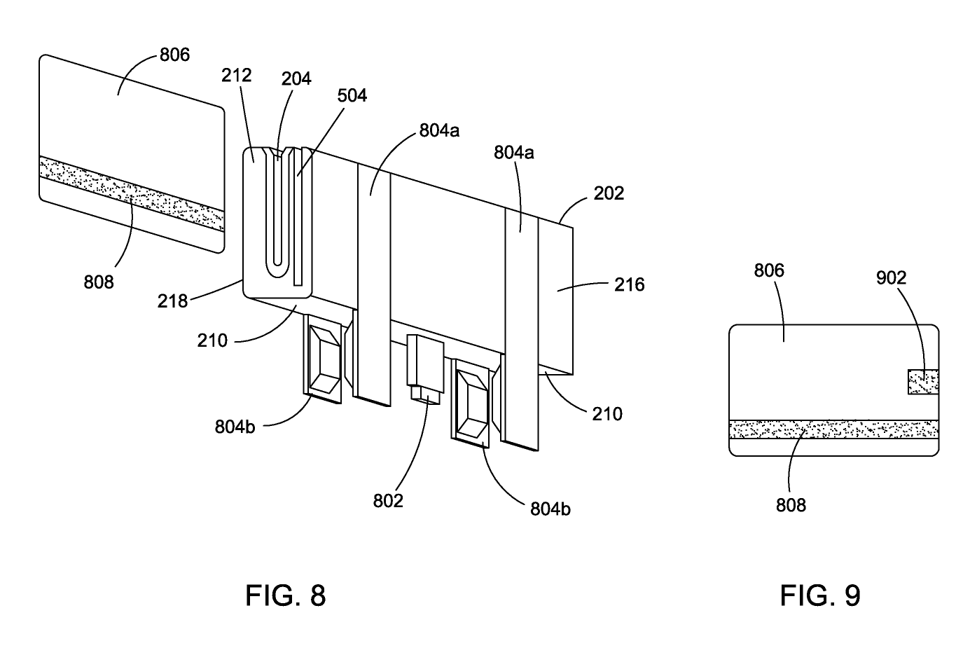

As shown in FIG. 2, the card reader 102 may include: a card reader body 202; an information reading area 204 configured to receive a card (e.g., card 806 shown in FIG. 8) having information stored thereon; a connection device 206 configured to connect the card reader body 202 to the mobile device 104 and transmit the information read from a card to the mobile device 104; and a first stability arm 108a and a second stability arm 108b configured to limit movement of the card reader body 202 with respect to the mobile device 104.

Mobile devices may include any electronic mobile device adapted to access a wired or wireless network, such as a mobile phone, a personal digital assistant, a wireless laptop computer, a personal computer, and combinations thereof by way of non-limiting examples. Mobile devices may include any electronic mobile device configured to receive card information from a card reader, such as card reader 102, and transmit the card information to remote locations (e.g., computer accessible to a credit card company) via a wired or wireless network. Mobile devices may be any mobile device configured to receive information associated with the card information (e.g., transaction confirmation) from the remote locations. Networks may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between the mobile device and other devices (e.g., remote computing systems, routers, mobile devices). Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication between the mobile device and other devices.

The card reader body 202 may include a top 208 and an opposing bottom 210 spaced from the top 208. The card reader body 202 may also include a front 212 and an opposing back 214 spaced from the front 212. The front 212 and back 214 each extend between the top 208 and bottom 210. The card reader body 202 may further include a first side 216 and an opposing second side 218 spaced from the first side 216. The first side 216 and the second side 218 each extend between the top 208 and the bottom 210 and extend between the front 212 and the back 214.

### Information Reading Areas and Information Readers

As shown in the embodiment in FIG. 2, the information reading area 204 may be disposed on the top 208 and extend between the front 212 and the back 214. Other embodiments may include information reading areas disposed at different locations (e.g., front, back, side) of a card reader. The information reading area 204 shown in FIG. 2 is substantially centered on the top 208. Other embodiments may include information reading areas that are offset on portions of the card readers. The geometry of the information reading area 204 shown in FIG. 2 is exemplary. Other embodiments may include information reading areas having geometries different than the geometry of the information reading area 204 shown in FIG. 2.

Embodiments may include one or more information reading areas that are sized and shaped to receive different types of cards and may include different types of readers. The information reading area 204 shown in FIG. 2 may be configured to receive a card having a magnetic stripe with information stored thereon and may include a magnetic reader (e.g., magnetic reader 302 shown in FIG. 3) configured to read information on a magnetic stripe of a card 806 (shown in FIG. 8). In some embodiments, the information reading areas configured to receive the card may include one or more information readers configured to read information stored on the cards. In other embodiments, information readers may be separate from the information reading areas, but proximate to the information reading areas.

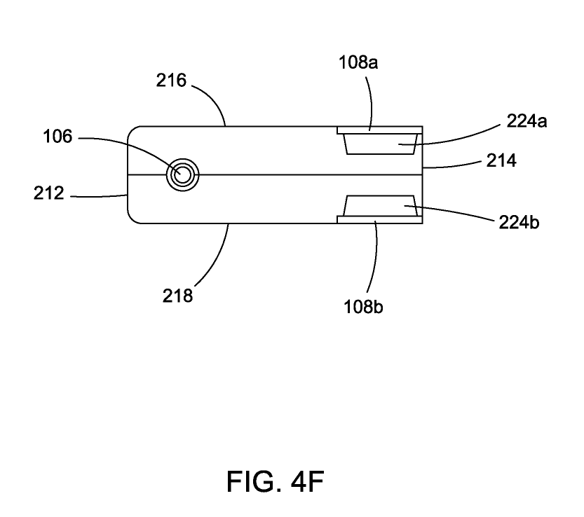

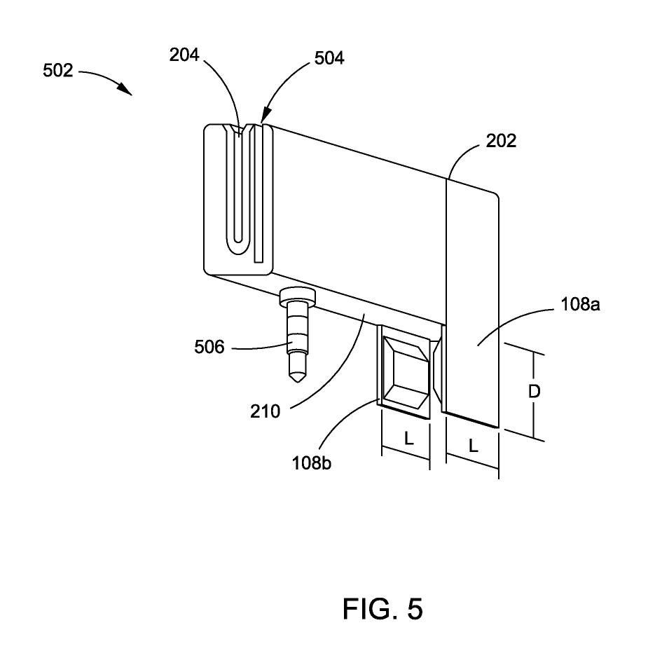

Information readers may also include EMV readers, combination readers, contact readers, contactless readers (e.g., RFID readers) and any other reader capable of reading card information. For example, in some embodiments, as shown in FIG. 5, a card reader 502 may include a plurality of information storage areas 204 and 504. As shown in FIG. 5, card reader 502 may include a magnetic stripe information storage area 204 and an EMV (Europay, MasterCard and Visa) information storage area 504. The EMV storage area may be configured to receive card 806 having EMV information stored thereon. The EMV storage area may include an EMV reader (not shown) configured to read information on an integrated circuit chip 902 of the card 806, as shown in FIG. 9. In some embodiments, the EMV reader at or proximate to EMV information storage area 504 may be a contact reader. For example, a microprocessor chip may be embedded in a small cavity behind a contact plate. When a card is received into the information reading area, the contact allows the chip to connect to the EMV reader, enabling the chip to get power from and exchange data with a terminal. In other embodiments, the EMV reader 504 may be a contactless reader. For example, a contactless chip card may be held within a couple of inches of a contactless-capable EMV reader. The EMV reader may energize the chip embedded in the card and allows exchange of data via radio frequency.

In some embodiments, a single information reading area (e.g., information reading area 204 shown in FIG. 8) may be configured to receive a card 806 having magnetic stripe information 808 and a same card 806 or different card having EMV information on chip 902 (shown in FIG. 9). The single information reading area 204 may include any combination of readers, such as a magnetic stripe information reader 302 and an EMV reader (not shown). In some embodiments, single information reading areas may include contact readers and contactless readers. Embodiments may include card readers having any number of card reading areas each including a different type of reader, such as a magnetic information reader, a contact EMV reader, a contactless EMV reader or other types of contact and contactless readers. Readers may also be configured to receive text payments, magnetic stripe information payments and EMV payments while remaining firmly attached to the mobile device via various ports.

Embodiments may include card readers indicating the location information reading areas. For example, some aspects may include coloring (e.g., red) a portion of an information reading area and/or coloring a portion of the card reader proximate to the information reading areas to indicate to a user the location for placing (e.g., swiping) a card. Some aspects may include a symbol, such as an arrow 230 (shown in FIG. 2 and FIG. 4E) to indicate to a user the location for placing a card and the direction for swiping the card.

### Connection Devices

The card reader 102 may include a connection device 206 configured to connect the card reader body 202 to the mobile device 104 and transmit information to the mobile device 104. As shown in FIG. 2, connection device 206 may be disposed on the bottom 210 of the card reader body 202 and extend in a first direction 220 away from and substantially perpendicular to the bottom 210 the card reader body 202. In some embodiments, card reader body 202 may include a connection device housing 206 configured to house a portion of the connection device 106.

Connection device 106 may be configured to be removably connected to the mobile device 104. For example, as shown in FIG. 1, connection device 106 is connected to mobile device 104, thereby connecting card reader 102 to mobile device 104. Embodiments may include card readers configured to be mechanically, electrically and/or optically connected to a mobile device. As shown in FIG. 2, connection device 106 may be an audio jack. Connection devices 106 may also include mini-USB jacks, USB jacks, iPhone jacks, serial jacks, parallel jacks, optical jack and/or any other jack configured to mechanically, electrically and/or optically connect a card reader to a mobile device. Connection devices may electrically connect the card reader 102 to mobile device 104 to providing an electrical connection to send card information received by an information reader, such as magnetic reader 302 (shown in FIG. 3), to the mobile device 104 and/or to supply power to the card reader 102.

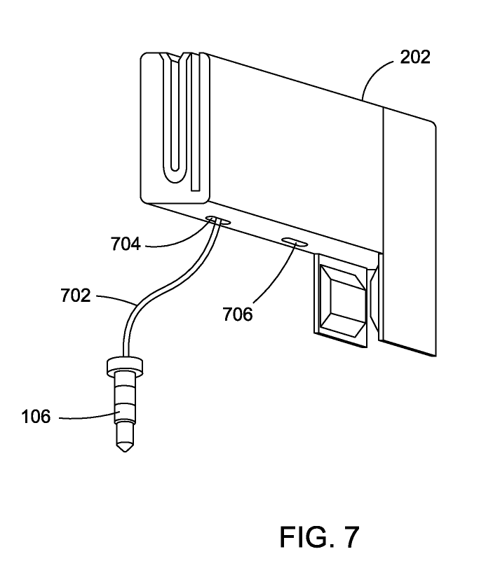

In some embodiments, a connection device 106 may be removably coupled to the card reader body 202. For example, as shown in FIG. 7, the connection device 106 may be removably coupled to the card reader body 202 via an information medium, such as a wire 702. In some aspects, wire 702 may extend from and retract to the card reader body 202 to facilitate connection to mobile devices 104. Aspects may include connection devices that are coupled directly to the card reader bodies without the use of information mediums such as wires. In some embodiments, connection devices may be fixed to card readers. Further embodiments may include movable connection devices that move along one or more portions of the card readers. For example, USB jack 802 shown in FIG. 8 may slide along bottom 210 of card reader body 202 to facilitate connection to mobile devices 104.

In some embodiments, a connection device coupling element, such as wire 702 or another coupling element, may be configured to be coupled to a plurality of different types of connection devices. For example, coupling device (audio jack) 106 shown in FIG. 7 may be removed and another type of jack (e.g., USB jack 802 shown in FIG. 8) may be coupled to wire 702. In some embodiments, as shown in FIG. 7, a card reader body 202 may include a plurality of connection points 704 and 706. Each connection point 704 and 706 may be configured to include a connection device, an information medium or a coupling element.

In some embodiments, card readers and the mobile devices may communicate with each other via wireless connections, which may be implemented using Wi-Fi, WiMAX, and Bluetooth, infrared, cellular networks, satellite or any other wireless connection methodology generally known in the art.

### Circuitry and Power Supplies

As shown in the embodiment at FIG. 3, a card reader 102 may include circuitry 304 configured to process information and/or facilitate communication between the information reader 302 and the wireless device 104. In some embodiments, circuitry 304 may include a system memory (e.g., ROM or flash memory) for storing software (e.g., information and instructions) to be executed by processors (not shown).

As shown in FIG. 3, the card reader 102 may include a power supply 306 for supplying electrical power to card reader 102. In some embodiments, a power supply may be a rechargeable power supply. In some embodiments, a power supply may be a replaceable power supply (e.g., a replaceable battery). In some embodiments, a power supply may be a regulated power supply to regulate load current or voltage supplied by an energy source. The power supply may receive energy from a plurality of sources that include: electrical transmission systems that may convert AC line voltage to DC voltage; the electrical system of the mobile device 104 that the card reader 102 is connected thereto; and solar power sources via solar storage cells on the card reader 102. The geometry of the power supply 304 shown in FIG. 3 is exemplary. Embodiments may include power sources having different geometries than the power source 306 shown in FIG. 3. In some embodiments, card readers may not include a power supply and the card readers may receive power directly from the mobile device that the card reader 102 is connected thereto. For example, power may be supplied to the card reader 102 via one or more connection devices, such as audio jack 106 when the card reader 102 is connected to the mobile device 104.

### Stability Elements

When the card reader 102 is connected to the mobile device 104 via connection device 106, a card (e.g., card 806) may enter (e.g., swiped by a user) information reading area 204 so that an information storage reader (e.g., magnetic stripe reader 302) may read information stored (e.g., on a magnetic stripe) on the card 806. The swiping of the card through the information reading area 204, however, may cause the card reader 102 to move with respect to the mobile device 104, resulting in less reliable reads. For example, the reader may be unable to read information on the card when the card reader 102 moves with respect to the mobile device 104, causing the user to have to swipe the card again.

Embodiments of the invention provide one or more stability elements configured to limit movement of the card readers with respect to the mobile device. For example, the swiping of the card 806 through the information reading area 204 may cause the card reader body 202 to move rotationally about axis 222 of connection device 106. In some embodiments, as shown in FIG. 2, stability elements may include one or more stability arms 108a and 108b configured to limit the rotational movement of the card reader body 202 about axis 222 of connection device 106.

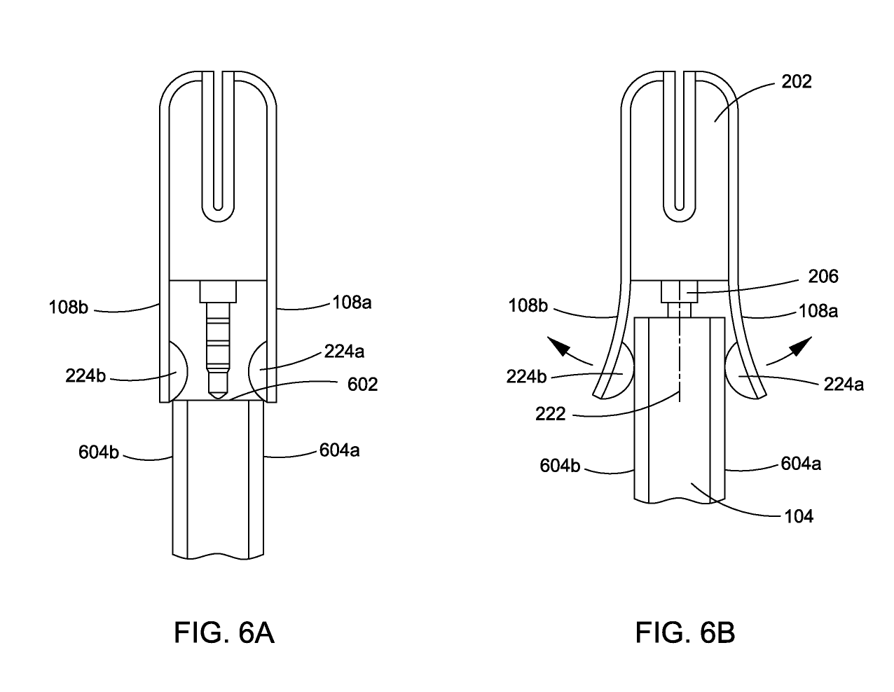

As shown in the embodiment at FIG. 2, first stability arm 108a and second stability arm 108b each extend away from the bottom 210 in substantially the same direction 220 as the connection device 106. The connection device 106 shown in FIG. 2 may be located proximate to the front 212 of the card reader body. The stability arms 108a and 108b may be spaced from the connection device 106 and located proximate to the back 214 of the card reader body 202. Accordingly, when a card is swiped through the information reading area 204 while the card reader 102 is connected to the mobile device 104, the stability arms 108a and 108b may be in contact with opposing sides 604a and 604b (shown in FIG. 6B) of the mobile device 104 and limit the rotational movement of the card reader body 202 about axis 222 of connection device 106.

In some embodiments, stability arms 108a and 108b (via guide elements 224a and 224b) may provide tension (e.g., via opposing forces applied to the opposing sides 604a and 604b of mobile device 104) when the stability arms 108a and 108b are in contact with the opposing sides 604a and 604b of mobile device 104 to limit the rotational movement of the card reader body 202. In some embodiments, stability arms 108a and 108b may be form fitted to the opposing sides 604a and 604b of mobile device 104, providing little or no tension when the stability arms 108a and 108b are in contact with the opposing sides 604a and 604b of mobile device 104. In some embodiments, stability arms 108a and 108b may be in close proximity to opposing sides 604a and 604b of mobile device 104 when the card reader 102 is connected to the mobile device 104 and may come into contact with the opposing sides 604a and 604b of mobile device 104 upon a slight rotational movement of the card reader.

As shown in FIG. 4B, portions stability arms 108a and 108b are disposed on top 208 and sides 216 and 218 and extend away from bottom 210. In some embodiments, however, portions of stability arms may not be disposed on the top or sides of card reader bodies. For example, stability arms may be mounted to card readers via hardware (e.g., screws, bolts, hinges, etc.). In some embodiments, stability arms may be unitary with the card reader bodies. Embodiments may also include removable stability arms that may be detached or otherwise removed from card reader bodies, movable (e.g., slidable) stability arms that may move along one or more portions of card reader bodies and retractable stability arms.

In the embodiment shown in FIG. 5, stability arms 108a and 108b may have a length L and extend a distance D from bottom 210 of card reader body 202. Embodiments may include stability arms have different lengths than length L and may extend distances different than distance D from bottom 210 of card reader body 202. In some aspects, stability arms 108a and 108b may be configured such that the length L, distance D and thickness (not shown) may provide sufficient stability for limiting rotational movement about the axis 222 of connection device 106.

In some embodiments, the stability arms 108a and 108b may each include a guide element 224a and 224b disposed on respective arm inner surfaces and proximate to respective distal ends of the stability arms 108a and 108b. When the card reader 102 is connected to the mobile device 104 via connection device 106, the guide elements 224a and 224b may facilitate the connection by causing the stability arms 108a and 108b to contact the opposing sides 604a and 604b of the mobile device 104.

FIG. 6A and FIG. 6B illustrate different states of a card reader body 102 being connected to mobile device 104. As shown at FIG. 6A, guide elements 224a and 224b may first come in contact with a top 602 of the mobile device 104. When card reader body 102 is connected to mobile device 104 as shown in FIG. 6B, guide elements 224a and 224b may come into contact with opposing sides 604a and 604b of the mobile device 104, thereby limiting rotational movement of the card reader body 202 about axis 222 of connection device 206.

In some embodiments, as shown in FIG. 2, guide elements 224a and 224b may be trapezoidal-shaped and may include a first tapered surface 226 to facilitate connection of the card reader body 202 on the mobile device 104. When card reader body 102 is connected to mobile device 104 via connection device 106, first tapered surfaces 226 of guide elements 224a and 224b may come in contact with a portion (e.g., top 602 shown in FIG. 6A) of mobile device 104. When card reader body 102 is connected to mobile device 104 via connection device 106, as shown in FIG. 6B, first tapered surfaces 226 of guide elements 224a and 224b may move along portions of the mobile device and contact opposing sides 604a and 604b of the mobile device 104, thereby limiting rotational movement of the card reader body 202 about axis 222 of connection device 206.

The geometry of the guide elements 224a and 224b shown in FIG. 2 are exemplary. Embodiments may include guide elements having geometries different than the trapezoidal shaped guide elements 224a and 224b shown in FIG. 2. For example, as shown in FIG. 6A and FIG. 6B, guide elements 224a and 224b may be semi-circular shaped. Other embodiments may include guide elements having any shape configured to facilitate the connection of the card reader 102 to the mobile device 104. In some embodiments, as shown in FIG. 6B, guide elements 224a and 224b may be configured to cause portions of corresponding stability arms to flex such that the guide elements 224a and 224b come into contact with opposing surfaces 604a and 604b of the mobile device 104. In other, embodiments, portions of the guide elements 224a and 224b may themselves change shape to facilitate connection of the card reader body 202 to the mobile device 104. In one embodiment, guide elements may include a rubber material to prevent damage to surfaces of the mobile device. Guide elements may be formed from one or more of a plurality of materials, such as rubber, plastic, Polycarbonate, ABS, Copolyester, Nylon, Tritan. In one embodiment, guide elements may be formed from one or more of a plurality of materials which meeting the following requirements: Modulus of Elasticity: 2100-2500; GPa Tensile Strength at Yield: 70; GPa minimum Elongation at Yield (Stain at Yield): 5.5% minimum.

Some mobile devices may include recesses on one or more sides, such as recess for a camera lens. Accordingly, when card reader 102 is connected to mobile device 104, the stability elements 108a and 108b may be received by a recess (not shown) on a surface of the mobile device 104. In some embodiments, a guide element 226 may include a second tapered surface 228 (shown in FIG. 2) to facilitate removal of the guide element 226 from the recess during removal of the card reader 102 from the mobile device 104.

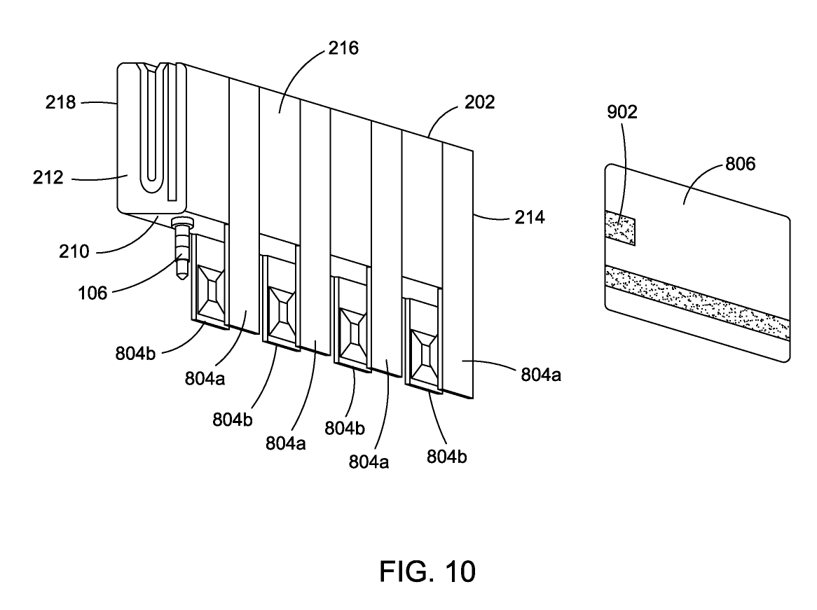

The geometry of the stability arms 108a and 108b shown in FIG. 1 through FIG. 4F is exemplary. Embodiments may include stability arms having geometries different than the stability arms 108a and 108b shown in FIG. 1 through FIG. 4F. Further, the number of the stability arms 108a and 108b shown in FIG. 1 through FIG. 4F is exemplary. Embodiments may include any number of stability arms configured to facilitate the connection of the card readers to mobile devices. For example, as shown in FIG. 8 and FIG. 10, embodiments may include a plurality of stability arms 804a extending from a first side 216 of the card reader body 202 and another plurality of stability arms 804b extending from an opposing side 218 of the card reader body.

As shown in FIG. 8, a card reader 102 may include a pair of stability arms 804a extending from bottom 210 on a first side 216 of card reader body 202 and a pair of opposing stability arms 804b extending from bottom 210 on opposing second side 216 of card reader body 202. In the embodiment shown in FIG. 8, stability arms 804a directly oppose 804b. In other embodiments, opposing stability bars may be offset from each other. In the embodiment shown in FIG. 8, each of the stability arms 804a and 804b are spaced from the USB connection device 802 at substantially equal distances. Embodiments may, however, include stability arms that are not spaced from the USB connection device 802 at substantially equal distances. In the embodiment shown in FIG. 8, each of the stability arms 804a and 804b extend from the bottom 210 at substantially equal distances. Embodiments may, however, include stability arms that extend from the bottom 210 at unequal distances.

As shown in the embodiment at FIG. 8, USB connection device 802 may be substantially centered between the stability arms 804a and 804b. In other embodiments, however, connection devices may not be substantially centered between the stability arms. For example, as shown in FIG. 10, audio jack connection device 106 is positioned proximate to front 212 of card reader body 202 and stability arms 804a and 804b are spaced evenly between front 212 and back 214 of card reader body 202.

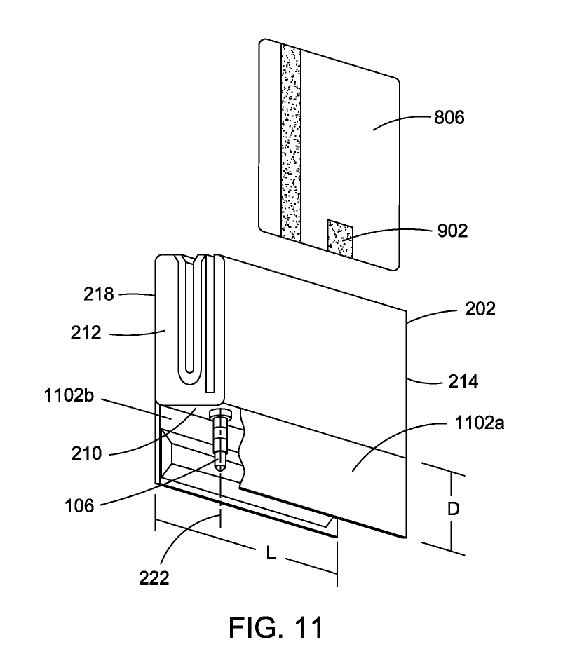

As shown in the embodiment at FIG. 11, a card reader body 202 may include a pair of stability elements 1102a and 1102b. As shown in the embodiment at FIG. 11, each stability element 1102a and 1102b may continually extend a length L from a front 212 of the card reader body 202 to a back 214 of the card reader body 202 and extend a distance D away from the bottom 210 of the card reader body 202. Embodiments may include stability elements extending any lengths between opposing portions (e.g., between front and back) of card readers and may extend any distance from bottoms of card readers to limit movement of the card readers (e.g., rotational movement about connection device axis). In some aspects, stability arms 1102a and 1102b may be configured such that the length L, distance D may provide sufficient stability for limiting rotational movement about the axis 222 of connection device 106.

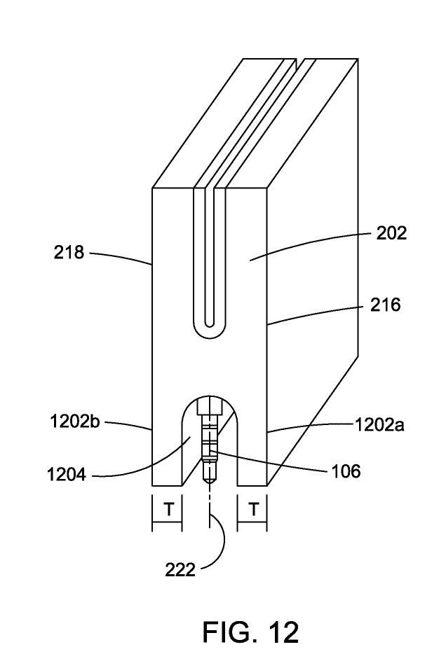

In the embodiment shown at FIG. 12, stability elements 1202a and 1202b may be unitary with the card reader body 202. The stability elements 1202a and 1202b are located on opposing sides 216 and 218 to form a channel 1204 which houses connection device 106. The stability elements 1202a and 1202b include a thickness T. The thickness T may be determined based on an amount of thickness for provide stability to limiting rotational movement about the axis 222 of connection device 106. The unitary configuration may provide greater stability for limiting rotational movement.

Embodiments include stability arms that may extend from the card reader bodies at lengths that are substantially the same as, shorter than or longer than the lengths that one or more connection devices extend from the card reader body.

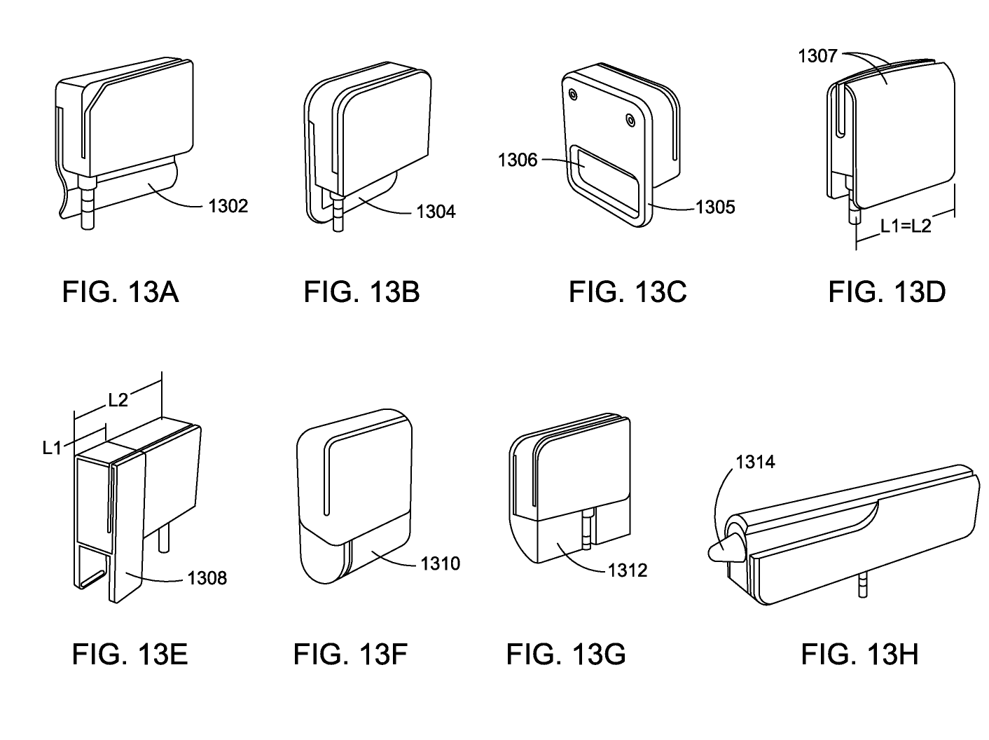

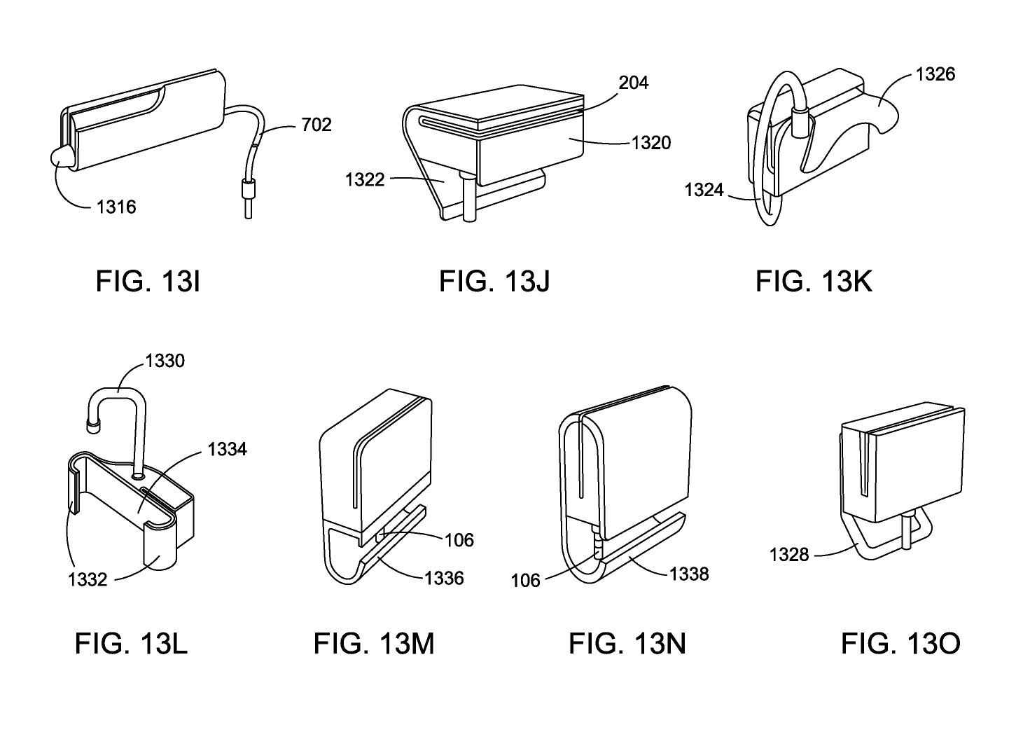

Embodiments may include card readers having geometries different than card readers described above. For example, FIG. 13A through FIG. 13K illustrate other types of exemplary card readers configured to be connected to mobile devices. In some embodiments, card readers may include a stability element on a single side of the card reader body. For example, as shown in FIG. 13A, a card reader may include a stability element 1302 located on a single side of the card reader body that may be configured to be coupled to a user's belt. The card readers shown in FIGS. 13B and 13C include other stability elements 1304 and 1305 on a single side of the card reader body. As shown in FIG. 13C, stability element 1305 may include an opening 1307 that may be used to be couple the card reader to a lanyard (not shown).

Embodiments may include stability elements (e.g. stability arms) having different lengths. For example, as shown in FIG. 13C, stability elements 1307 may extend a length L1 that is substantially the same as the length L2 of the card reader body. As shown in FIG. 13E, however, stability elements 1308 may extend a length L1 that is less than the length L2 of the card reader body. In some embodiments, stability elements may extend lengths that are greater than the length of the card readers.

Some exemplary card readers, such as those shown at FIGS. 13H and 13I, may be stylus-shaped or pen-shaped. The card readers may include tips 1314 and 1316, which may be writing instruments or covers for writing instruments or touch screen instruments. As shown in FIG. 1316, a card reader may include a connection device coupled to the card reader via wire 702 that may extend from and retract to the card reader body to facilitate connection to mobile devices.

In the embodiments described above, car reading information areas 204 are disposed on tops 208 of card reader bodies 202. As shown in FIG. 13J, however, front swipe card readers may include car reading information areas 204 on a front 1320 of card readers. Front 1320 may be parallel with a front of a mobile device and portion of stability element 1322 may be in contact with an opposing rear of the mobile device to limit movement of the card reader with respect to the mobile device.

Some exemplary card readers, such as those shown at FIG. 13K, may include hook-shaped coupling elements 1324 or other coupling elements 1326 that extend from the card reader bodies. For example, as shown in FIG. 13K, card readers may include hook-shaped coupling element 1324 and coupling element 1326 that may be used to couple the card readers to external objects, such as backpacks, briefcases, etc.

In the embodiment at FIG. 13L, the exemplary card reader may include an hooked-shaped audio jack coupling element that extends from the card reader and is configured to include an audio jack (e.g. 3.5 mm audio jack (not shown)) on a distal end to be connected to the device. As shown, the card reader may also include curved stability elements 1332 that would wrap around side portions of a mobile device. In this exemplary embodiment, the card reader may be configured to be coupled to the back of a mobile device, such that the inner portion 1334 abuts or is adjacent to the rear portion of the mobile device.

As shown in the embodiment at FIG. 13F, FIG. 13G, FIG. 13M and FIG. 13N, the card reader may include a movable and/or a removable protective portion, such as protection portion 1310 shown in FIG. 13F, protection portion 1312 (shown in FIG. 13G), protective portion 1336 (shown in FIG. 13M) and protection portion 1338 (shown in FIG. 13N) configured to limit harm or undesirable contact to the audio jack 106.

In one aspect of the embodiment, the audio jack 106 may be exposed by moving (e.g. pivoting, rotating, sliding) the protective portion 1310, 1312, 1336, 1338 to a position such that the audio jack 106 may be connected to the mobile device. After the card reader is connected to the phone via the audio jack 106, the protective portion 1310, 1312, 1336, 1338 may be used as a stability element to limit movement of the card reader body with respect to the mobile device (e.g. limit rotational protective portion 1336 may automatically (or manually) move back the position shown at FIG. 13M or 13N. In another aspect, the protective portion 1310, 1312, 1336, 1338 may be removed from the card reader so that the audio jack 106 may be connected to the mobile device and replaced back the position shown at FIG. 13M or 13N. In the embodiment at FIG. 13O, the card reader may include a movable portion spring loaded portion 1328 configured to be coupled to an external object (e.g. to a user's belt)

### Card Reader Caps

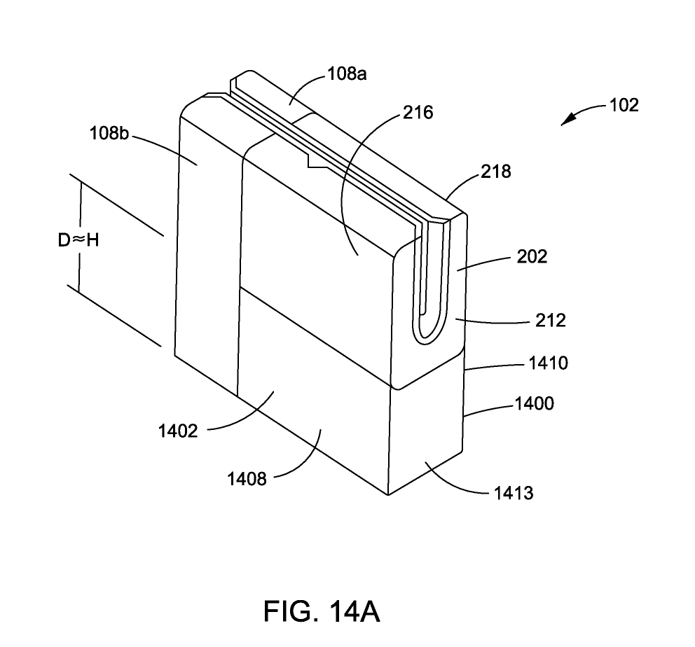

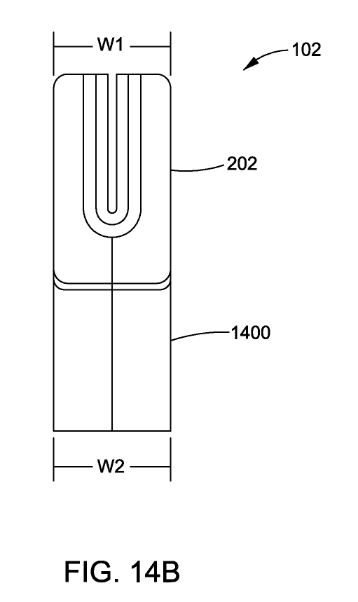

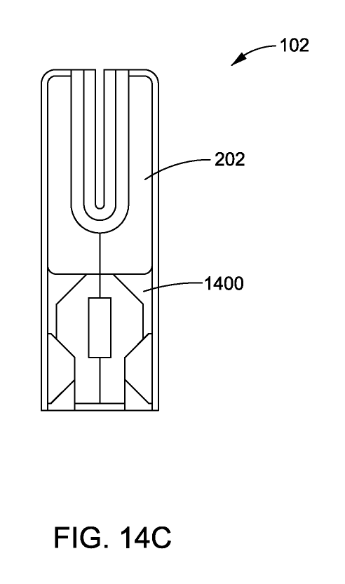

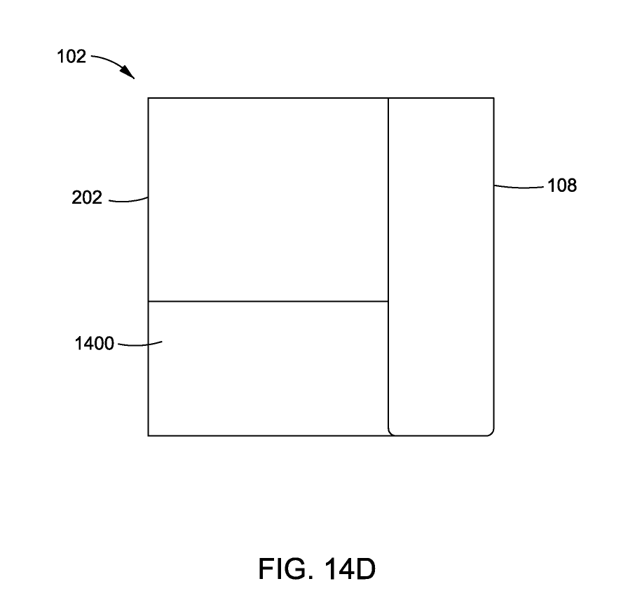

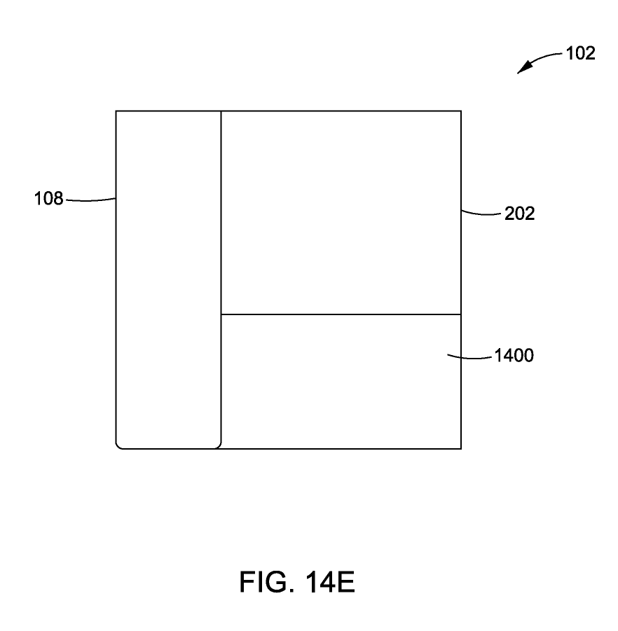

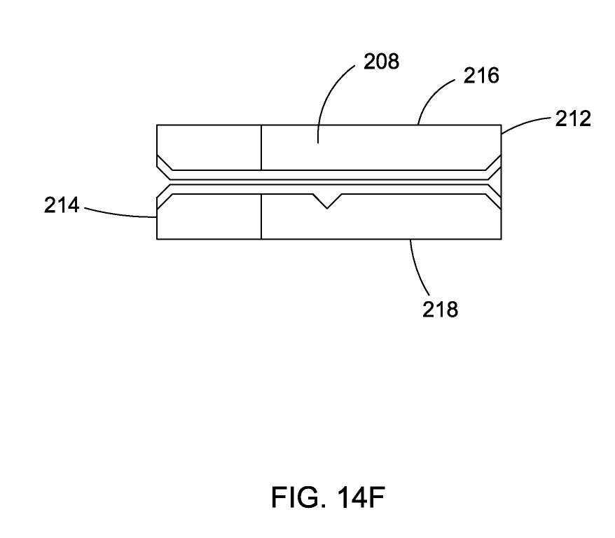

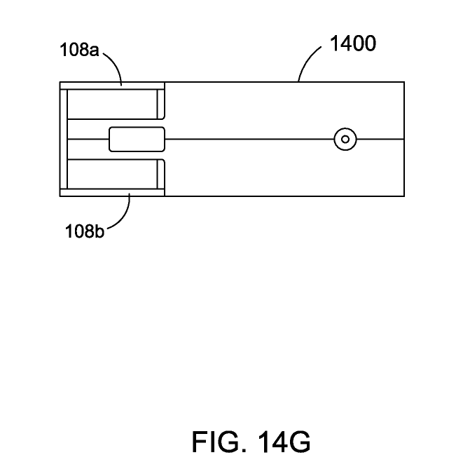

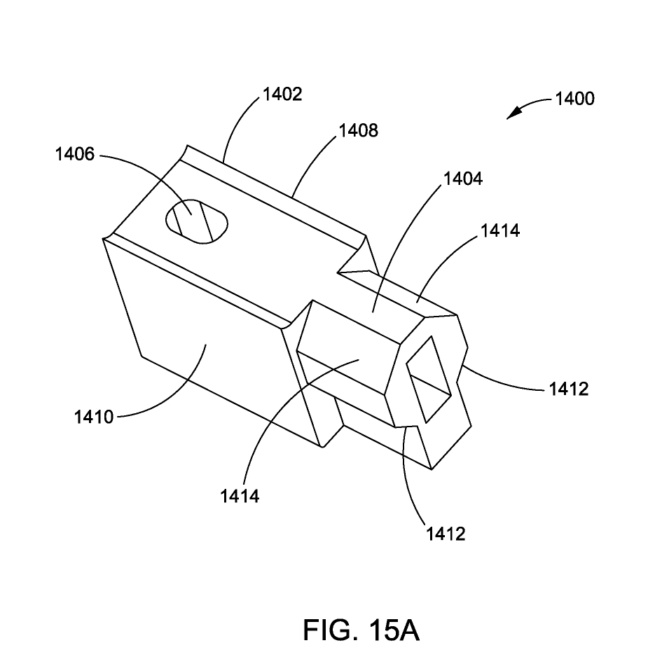

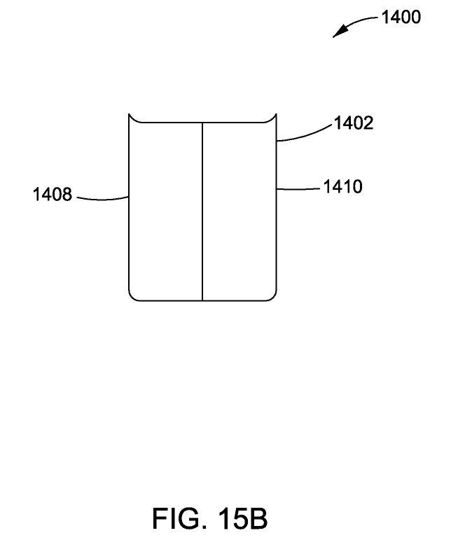

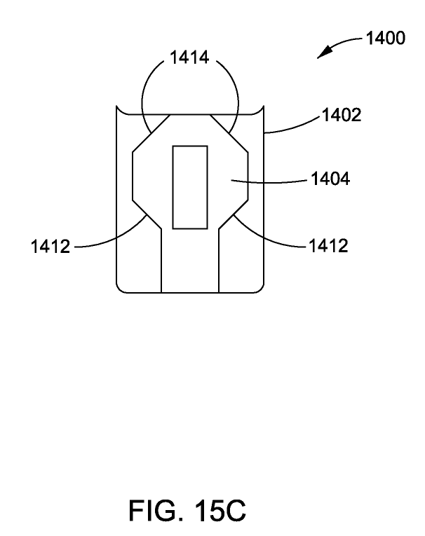

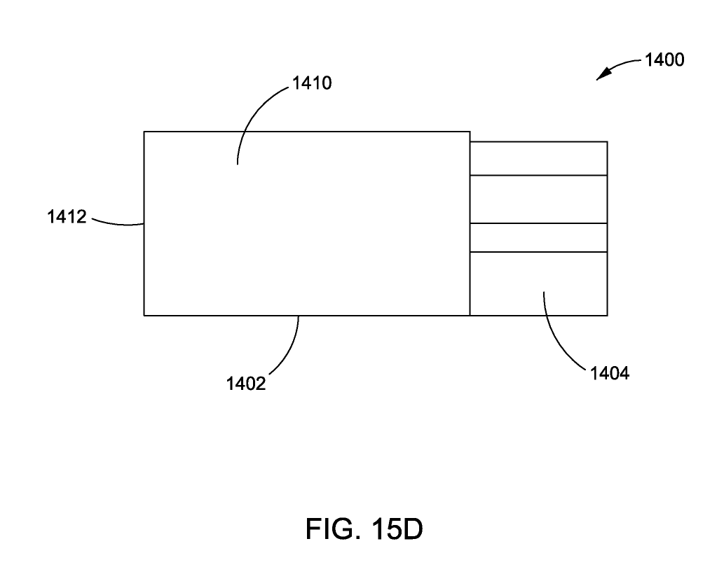

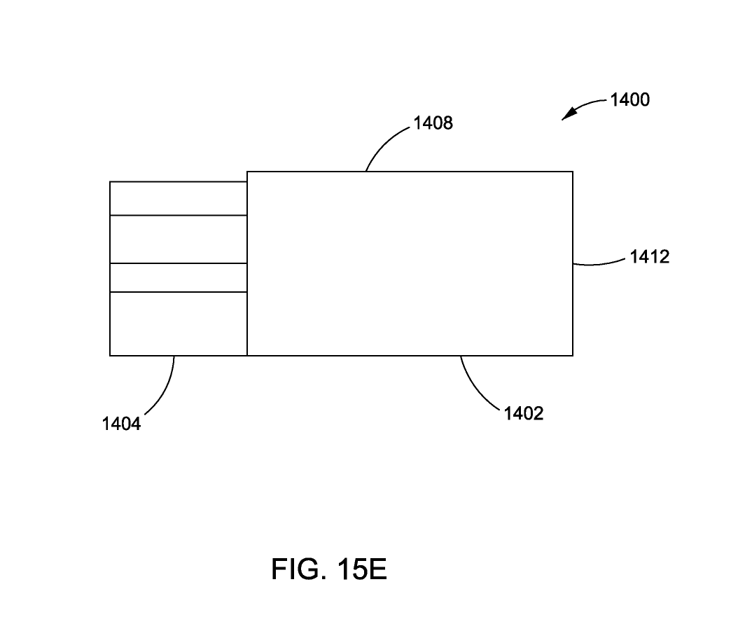

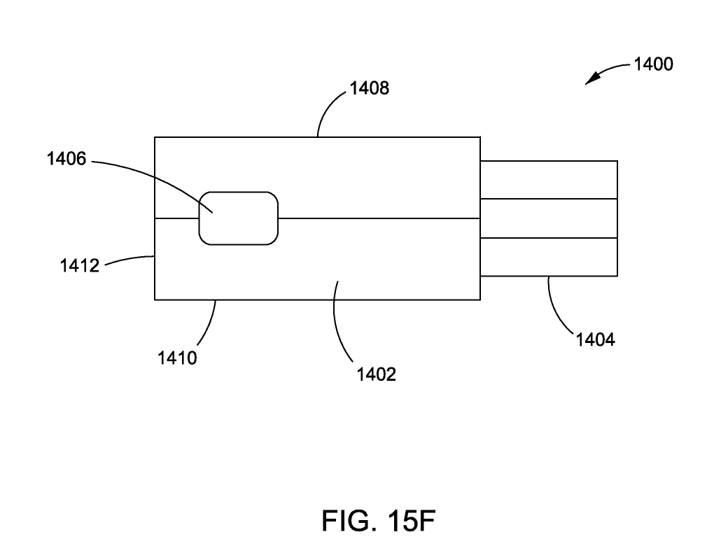

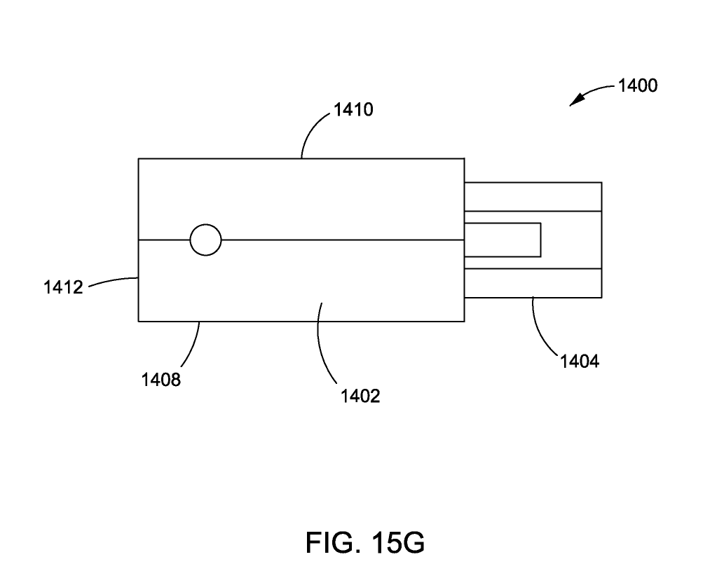

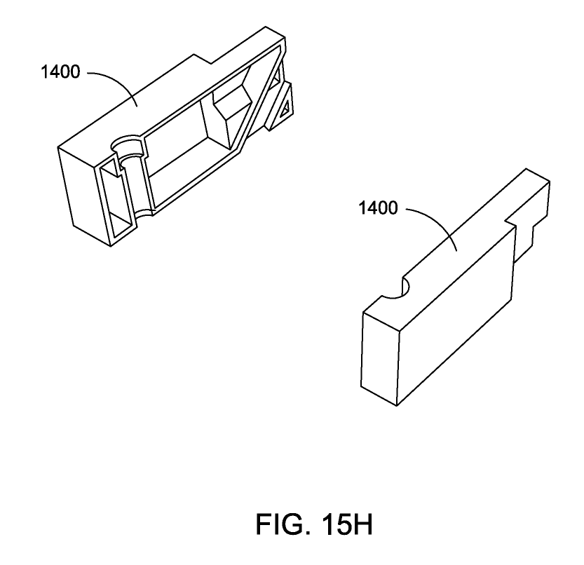

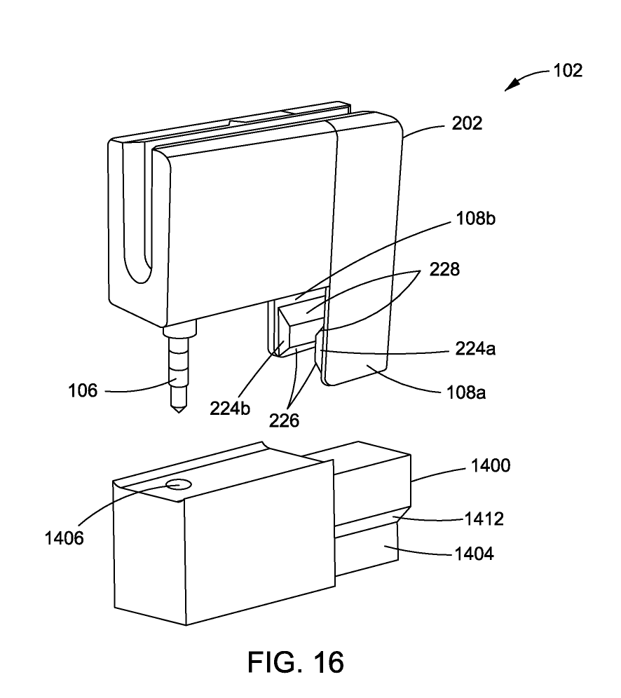

FIG. 14A through FIG. 14G show a perspective view, front view, back view, top view, bottom view, first side view and second side views, respectively, of an exemplary card reader 102 coupled to a cap 1400 for use with embodiments of the present invention. FIG. 15A through FIG. 15H show a perspective view, front view, back view, top view, bottom view, first side view, second side view and an exploded view, respectively, of the exemplary cap 1400 shown in FIG. 14A through FIG. 14G for use with embodiments of the present invention. FIG. 16 is a partially exploded view of the exemplary card reader and cap shown in FIG. 14A through FIG. 14G for use with embodiments of the present invention. The geometries of the card reader 102 and cap shown in FIG. 14A through FIG. 16 are exemplary. Other embodiments may include card readers and caps having geometries different than card reader 102 and cap 1400 shown in FIG. 14A through FIG. 16.

As shown in FIG. 16, cap 1400 may include a recess 1406 configured to receive connection device 106. As shown in the embodiment in FIG. 14A, a first portion of cap 1400 may have a height H extending from the card reader body 202 that is substantially equal to the distance D that stability bars 108 extend from the card reader body 202. As shown in FIG. 16B, the width of the cap W2 may be substantially the same as the width W1 of the card reader body 202. When card reader body 202 is connected to cap 1400 as shown in FIG. 14A, the opposing sides 216 and 218 and front 212 of the card reader body 202 combine together with opposing sides 1408 and 1410 and front 1413 of cap 1400 to form substantially continuous outer surfaces. Accordingly, the configuration of the card reader body 202 and the configuration of the cap 1400 together may form a rectangular-shaped card reader 102 shown in FIG. 14A, which may facilitate storage and prevent damage to components.

As shown in FIGS. 14A and 15A, the cap 1400 may include a first portion 1402. As shown in FIG. 15A, FIG. 15C and FIG. 16, the cap 1400 may include a second portion 1404 that is configured to be positioned between stability arms 108a and 108b. Second portion 1404 may include tapered edges 1412 and 1414. For example, as shown in FIG. 16, second portion 1404 of cap 1400 may include lower tapered edges 1412 (opposing lower tapered edge not shown) which minor and abut upper tapered edges 228 of guide elements 224a and 224b when the cap 1400 is installed on the card reader body 202. The configuration of the lower tapered edges 1412 may help to facilitate movement past the guide elements 224a and 224b during removal of the cap 1400 from the card reader body 202. As shown in FIG. 15A and FIG. 15C, the second portion 1404 may include both the lower tapered edges 1412 and upper tapered edges 1414. The configuration of the upper tapered edges 1414 of cap 1400 may help facilitate movement past the guide elements 224a and 224b during installation of the cap 1400 on the card reader body 202.

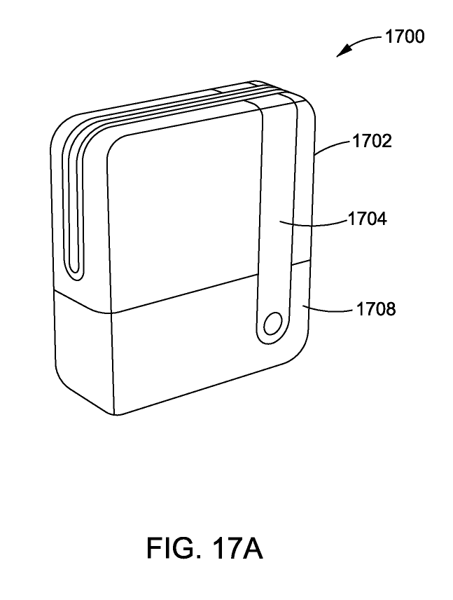

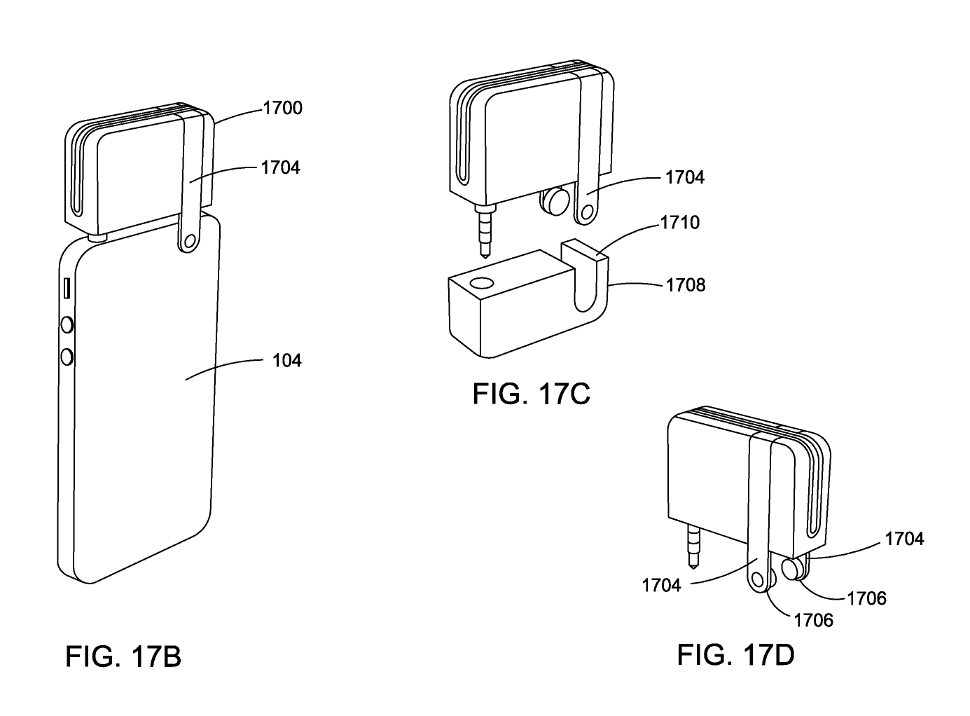

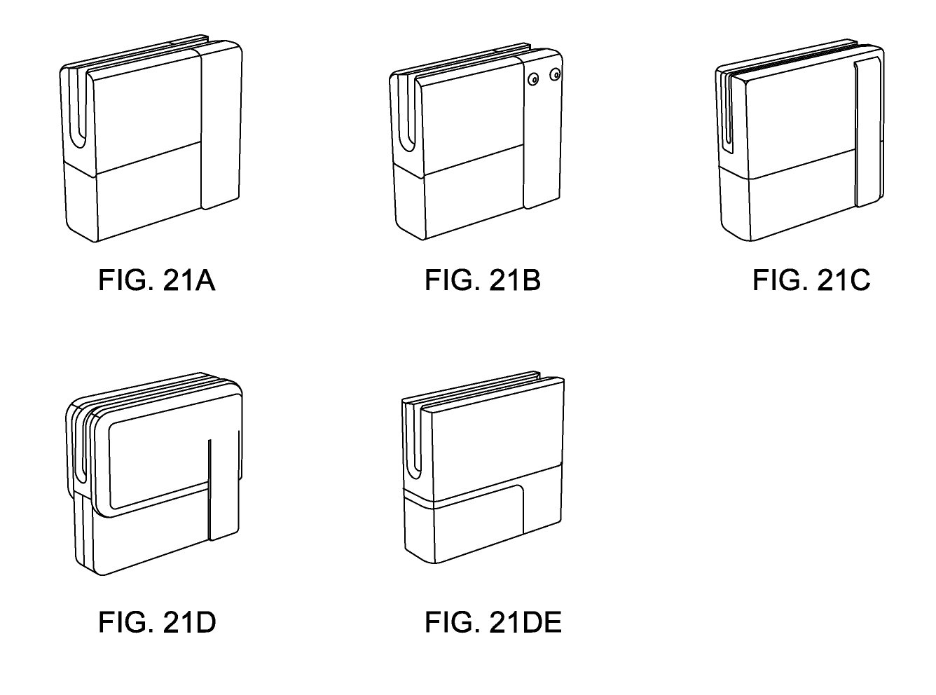

The geometries of the card reader 102 and cap shown in FIG. 14A through FIG. 16 are exemplary. Embodiments showing other exemplary card readers and caps having various geometries are shown in FIG. 17A through FIG. 21E. For example, as shown at FIG. 17A through FIG. 17D, card reader body 1702 of card reader 1700 may include stability arms 1704 having rounded edges at distal ends 1706. Cap 1708 may include a recess 1710 for receiving the stability arms 1702.

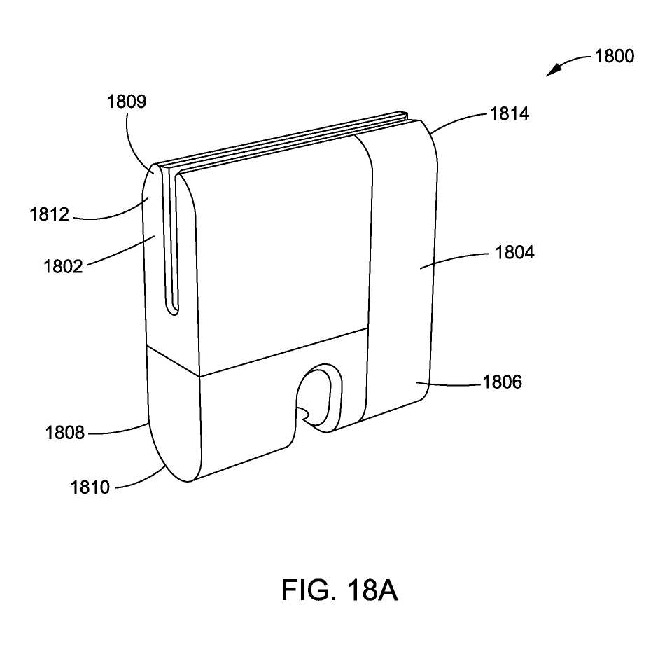

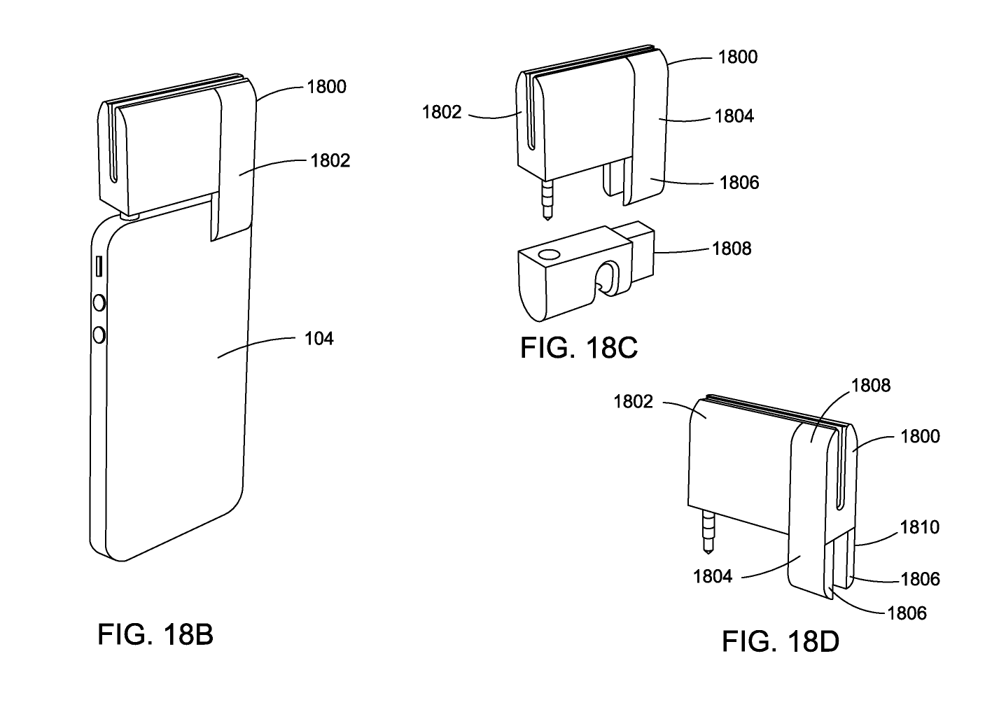

As shown at FIG. 18A through FIG. 18D, card reader body 1802 of card reader 1800 may include rounded portions extending inward toward the card reader at top 1809. The rounded portions may extend between front 1812 and back 1814. Cap 1808 may also include rounded portions extending inward toward the card reader 1800 at cap bottom 1810. Stability arms 1804 may also include rounded portions extending inward toward the card reader 1800 at distal ends 1806.

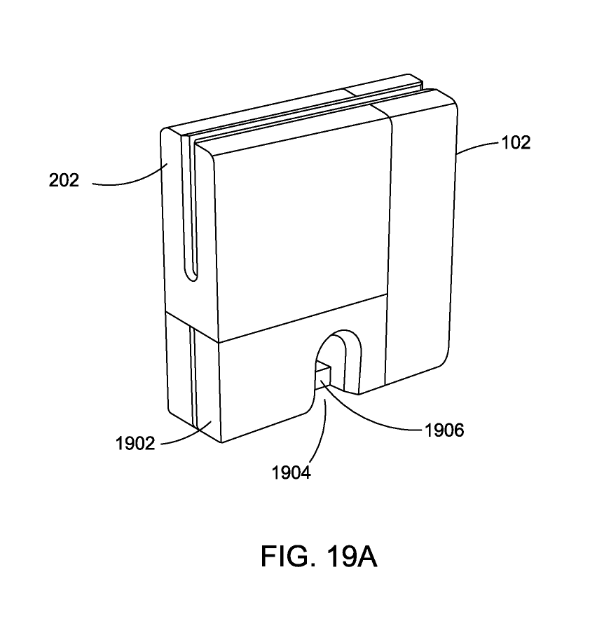

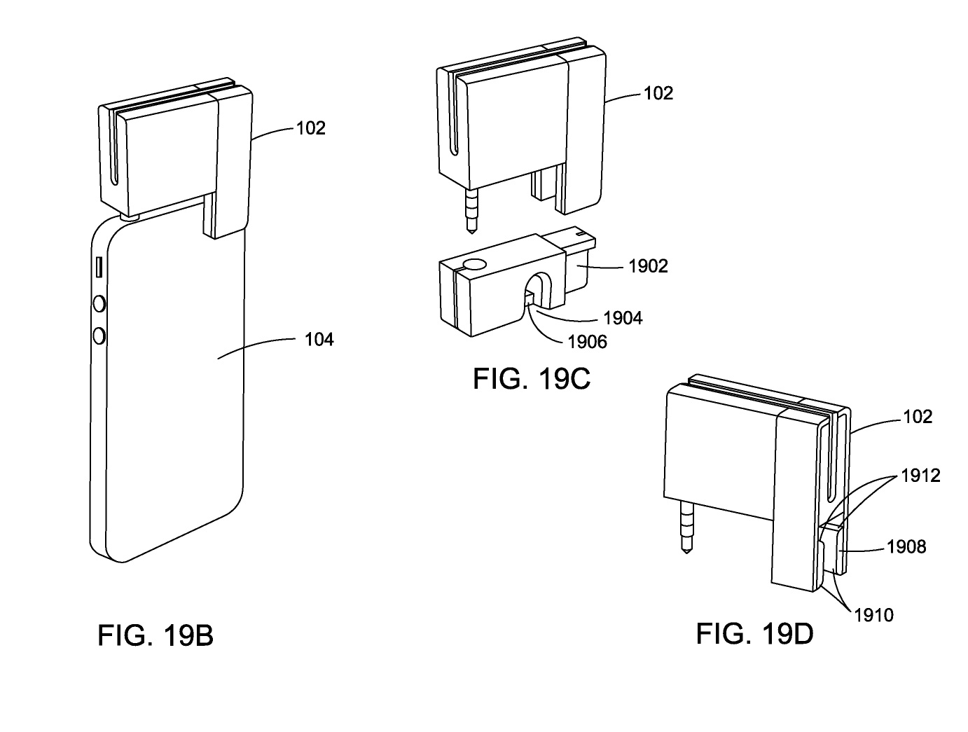

As shown in FIG. 19A, card reader body 202 of card reader 102 (shown in FIG. 1 and FIG. 2) may include another exemplary cap 1902. As shown at FIG. 19A and FIG. 19C, cap 1902 of card reader 1900 may include a recess 1906 disposed on cap bottom 1910 to provide a lanyard affordance, such as coupling device 1912. Lanyards may be used to couple card reader 1900 to other devices (e.g. key chains, hooks, etc.). As shown in FIG. 19D, guide elements 1908 may include tapered surfaces 1910 and 1912 that are sloped differently than tapered surfaces 226 and 228 (shown in FIG. 2). Tapered surfaces 1910 and 1912 provide larger flat surface areas that contact opposing sides 604a and 604b (shown in FIG. 6B) of the mobile device 104 to further limit movement of the card reader body 102 with respect to the mobile device 104.

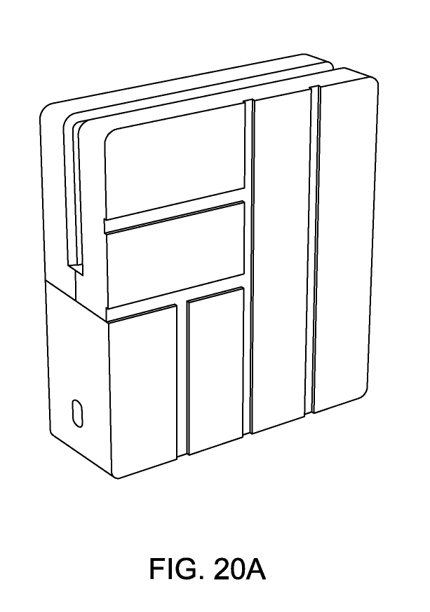

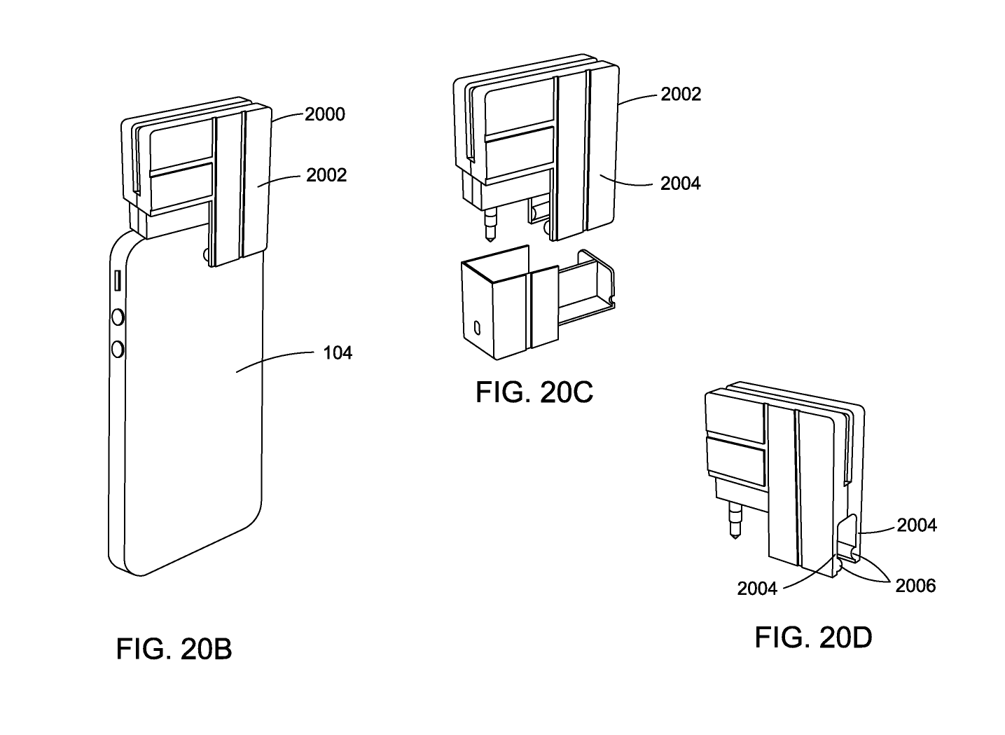

As shown in FIG. 20A to FIG. 20D, outer surfaces of card reader 200 may include patterns, indentations, etc. that may be uses to show various designs, such as pictures, trademarks, brands etc. As shown in FIG. 20C and FIG. 20D, the stability arm 2004 and guide elements 2006 may be unitary with card reader body 2002.

### Packaging

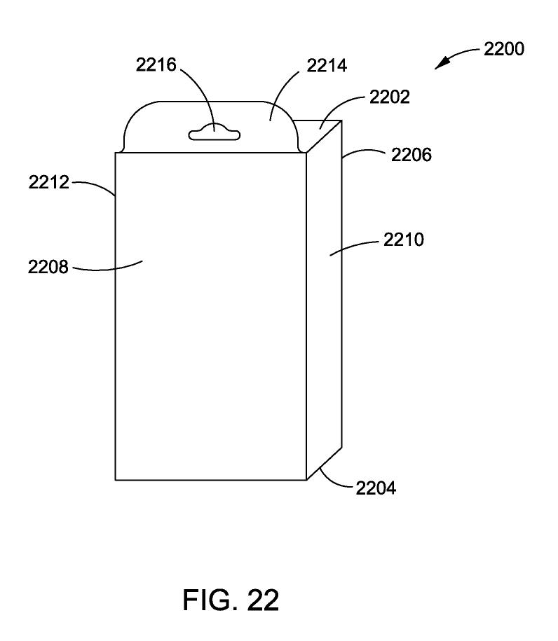

As shown in FIG. 22, the card readers may be stored in package 2200. Package 2200 may include a top 2202 and an opposing bottom 2204 spaced from the top 2202. The package 2200 may also include a front 2206 and an opposing back 2208 spaced from the front 2206. The front 2206 and back 2208 each extend between the top 2202 and bottom 2204. The package may further include a first side 2210 and an opposing second side 2212 spaced from the first side 2210. The first side 2210 and the second side 2212 each extend between the top 2202 and the bottom 2204 and extend between the front 2206 and the back 2208.

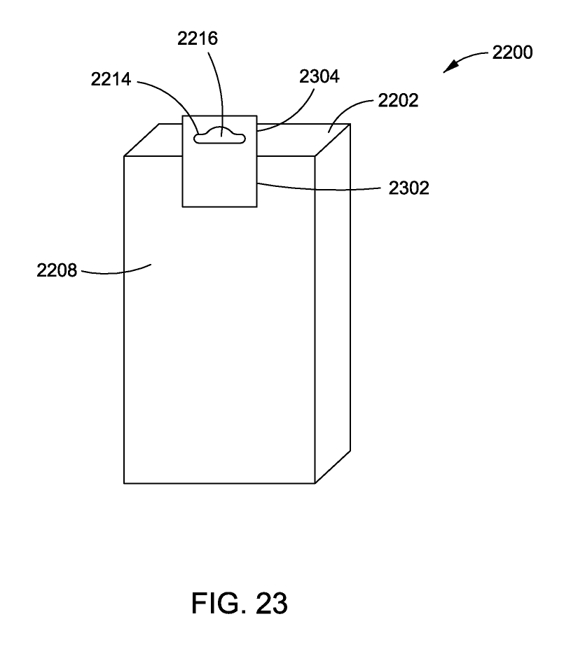

The package 2200 may include a peg holder 2214 having an opening 2216 configured to be positioned on a peg (e.g., j-peg) for display. As shown in FIG. 22, the peg holder 2214 may extend from back 2208 and away from top 2202 of package 2200. As shown in FIG. 23, however, a first portion 2302 of the peg holder 2214 may be disposed on a back 2208 of the package 2200 and a second portion 2304 having opening 2216 may extend from top 2202 of package 2200. Aspects of embodiments may include peg holder 2214 disposed on any portion of packages. In some embodiments, peg holders may be integrated with packages. In other embodiments, peg holders may be separately attached (e.g., via adhesive, Velcro, screws or other hardware) to packages. Embodiments may include umbrella-shaped openings as shown in FIG. 22-24. Other embodiments may include openings having different shapes (e.g., circular) configured to be positioned on a peg (e.g., j-peg) or other holding element for display.

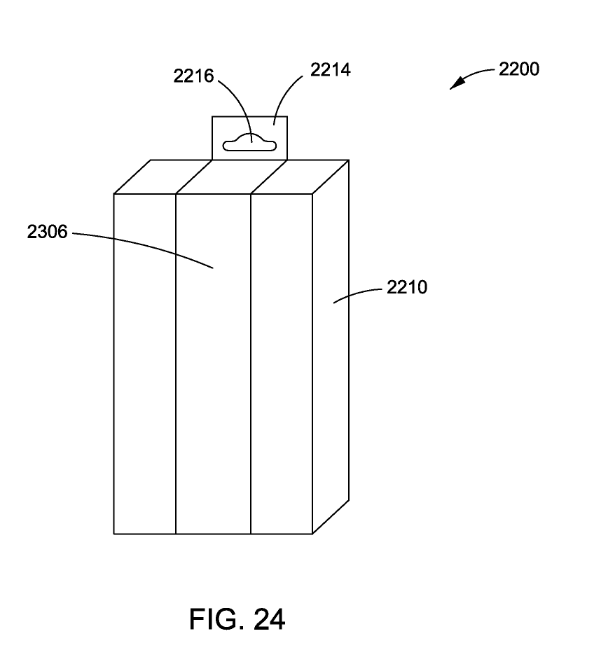

As shown in the embodiments in FIG. 23 and FIG. 24, a package 2200 may include a sleeve 2306 having an integrated peg holder 2214 disposed on a portion of the package 2200. For example, the sleeve 2306 may be substantially centered between opposing sides 2208 and 2210 of package 2200. In other embodiments, however, sleeves may not be substantially centered on packages and be disposed on any portions of packages.

The geometry of the packages, the peg holders and the openings shown in FIG. 22 through FIG. 24 are merely exemplary. Embodiments may include packages, peg holders and the openings having different geometries than those shown in FIG. 22 through FIG. 24.

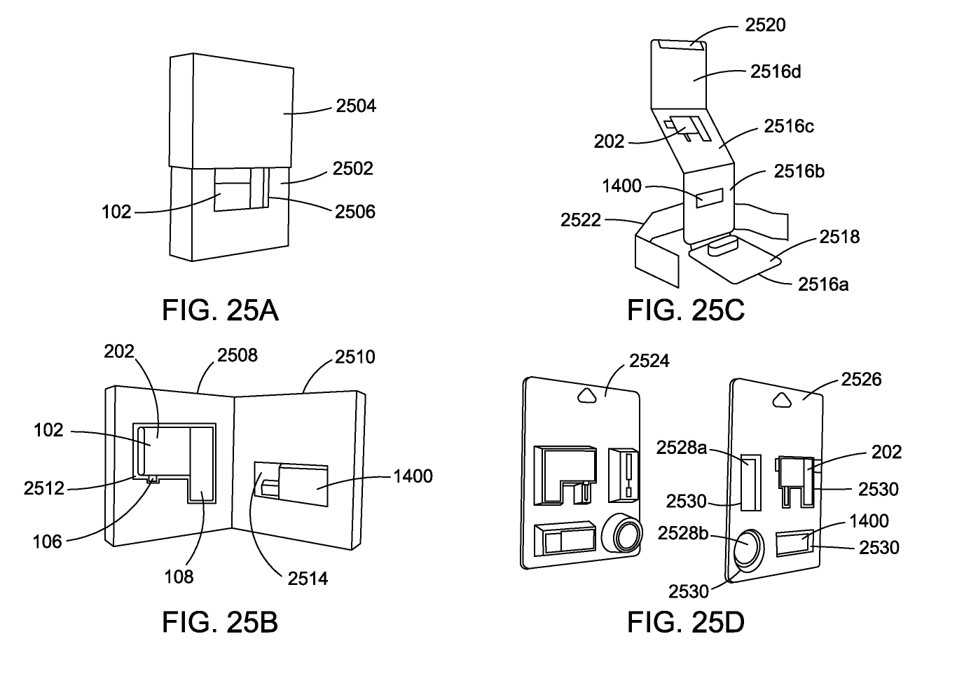

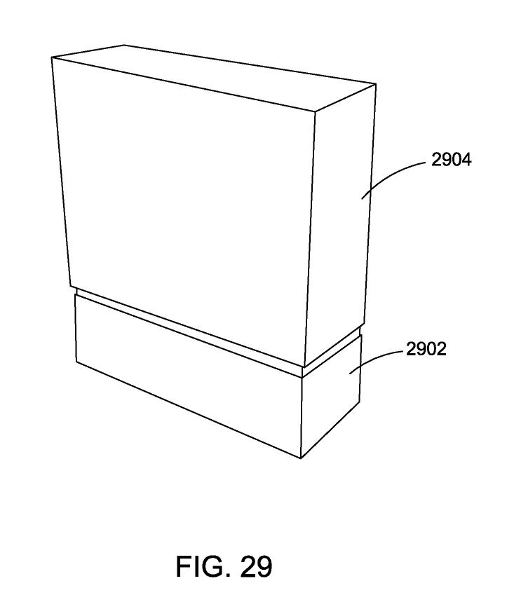

In some embodiments, the packaging may include an inner packaging portion 2502 and an outer packaging portion 2504. As shown in FIG. 25A, inner packaging portion 2502 may include a holding area (e.g., a recess) 2506 configured to hold the card reader 102. Outer packaging portion 2504 may be configured to house at least part of the inner packaging portion 2502. In some aspects of the embodiment, outer packaging portion 2504 may be configured to slide over the inner packaging portion 2502, as shown at FIG. 25A. In some embodiments, as shown in FIG. 29, outer packaging may include a first portion 2902 and a second portion 2904. Second portion 2904 may be configured to rest on first portion 2902.

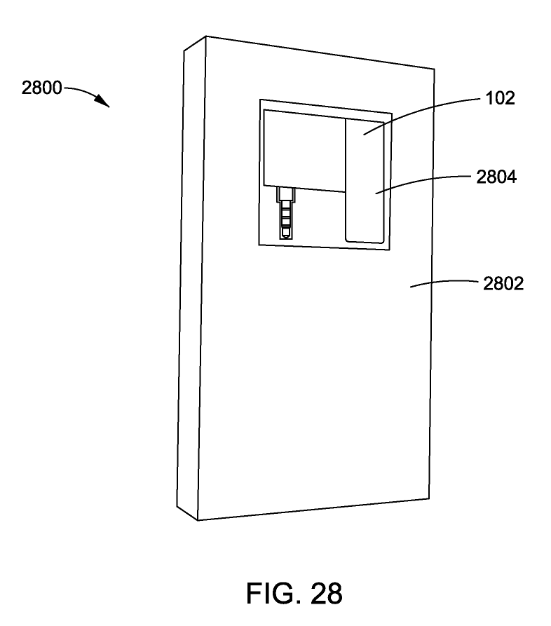

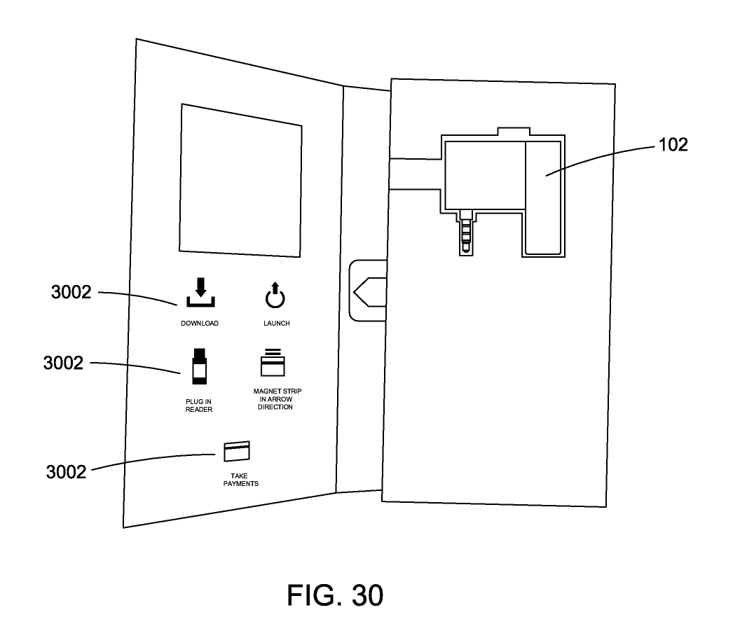

In the embodiment shown at FIG. 25B, the packaging may be a book-type packaging having a first book portion 2508 and a second book portion 2510. The first book portion 2508 may include a first holding area configured to hold portions (e.g., the card reader body 202, the connection device 106 and the stability arms 108) of the card reader 102. The second book portion 2510 may include a second holding area configured to hold another portion (e.g., cap 1400). Embodiments may include additional book portions and any number of holding areas disposed on any of the book portions. For example, as shown in FIG. 27, portions (e.g., the card reader body 202, cap 1400) of the card reader 102 and accessories (e.g. lanyard 2702) may be stored in first book portion 2704, while second book portion 2706 is not used to store any items, thereby providing a thinner packaging profile. As shown in FIG. 28, a book portion 2802 of packaging 2800 may include a window 2804 for displaying card reader 102. As shown in FIG. 30, book portions may display words and/or pictures to indicate various functions of the card reader 102.

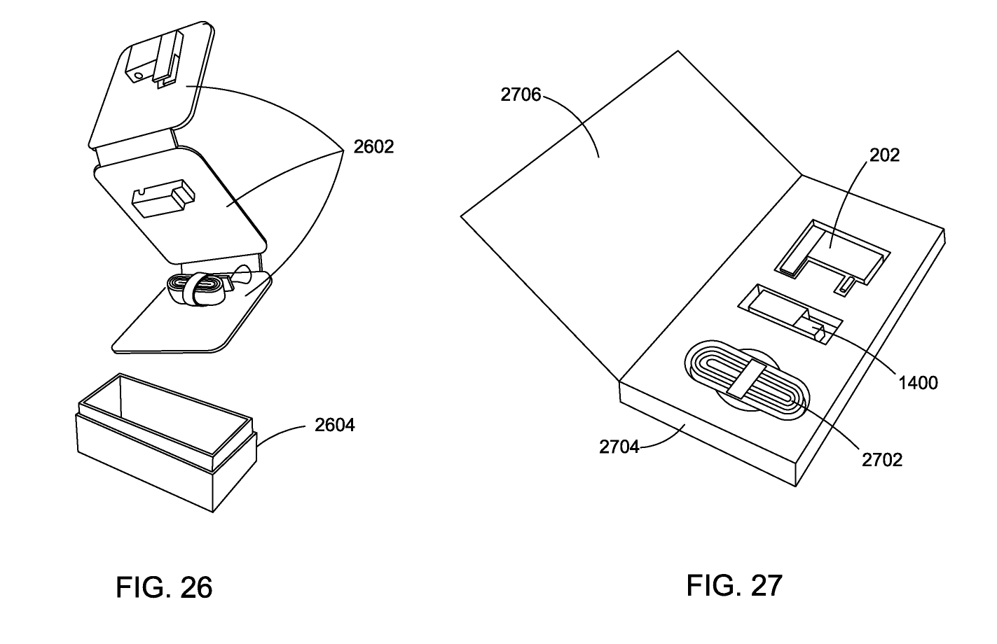

As shown in FIG. 25C, the packaging may include a plurality of folding portions 2516a, 2516b, 2516c and 2516d that are configured to unfold from each other. Portions (e.g., card reader body 202, cap 1400) of the card reader 102 and/or accessories may be coupled to folding portions 2516a, 2516b, 2516c and 2516d. The packaging may include a base folding portion 2516a having a first coupling portion 2518, intermediate folding portions 2516b and 2516c and a top folding portion 2516d having a second coupling portion 2520 configured to couple to the first coupling portion 2518. The packaging may also include an outer wrapping portion configured to at least partially house the folding portions 2516a, 2516b, 2516c and 2516d. Embodiments may include any number of folding portions configured to hold any portion of card readers and/or accessories. For example, as shown in FIG. 26, the packaging may include three folding portions 2602 that are configured to fold into a container, such as box 2604.

In the embodiment shown at FIG. 25D, the packaging may be a tray having a front 2524 and back 2526. As shown, back 2526 may include holding areas (e.g., recesses) 2530 configured to hold portions (e.g., card reader body 202, cap 1400) of the card reader 102 and accessories 2528a and 2528b. Front 2524 may include indicators (e.g., images) which display card reader components (e.g., card reader body 202, cap 1400, accessories 2528a and 2528b) held in the recesses 2530 disposed on the back 2526. Packaging trays may include any number of holding areas configured to hold card reader components and accessories.

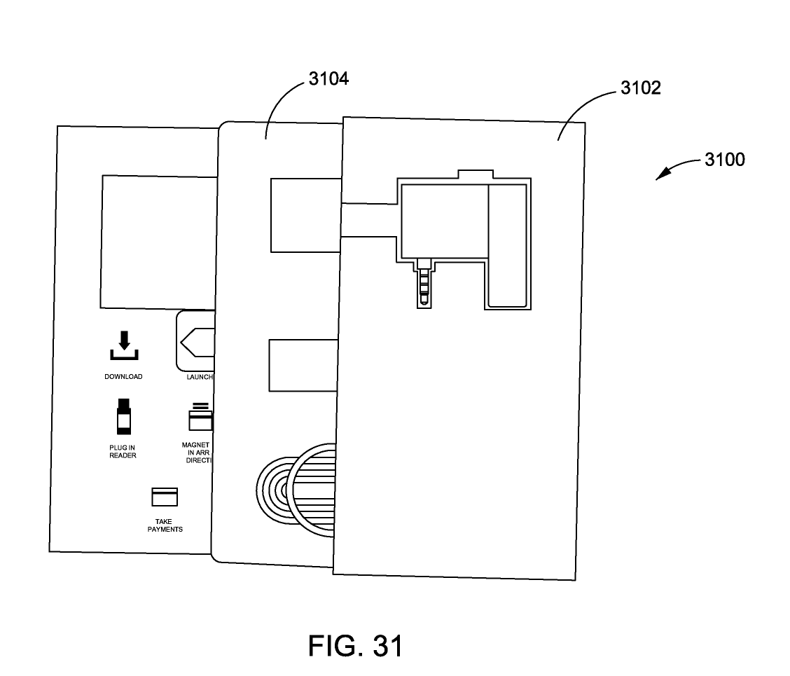

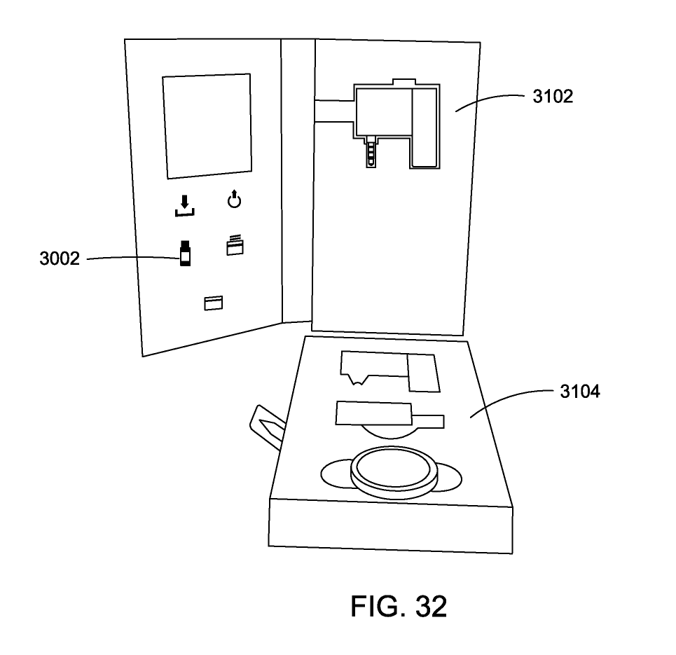

In some embodiments, packaging may combine different types of packaging. For example, as shown in FIGS. 31 and 32, a packaging 3100 may include a book portion 3102 and a tray portion 3104. As shown, tray portion 3104 may be stored within book portion 3102 and may be removed from book portion 3102.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A card reader for use with a mobile device configured to receive and transmit information, comprising:
a card reader body comprising:
an information reading area configured to receive a card;
an information reader configured to read information stored on the card;
a connection device disposed on the card reader body, extending in a first direction away from and substantially perpendicular to the card reader body and configured to be removably connected to the mobile device;
a first arm extending in the first direction away from the card reader body and spaced apart from the connection device; and
an opposing second arm extending in the first direction away from the card reader body and spaced apart from the connection device,
wherein the first arm and the second arm are configured to contact the mobile device and limit movement of the card reader body with respect to the mobile device when the card reader body is connected to the mobile device via the connection device.

2. The card reader of claim 1, wherein the first arm and the second arm are configured to contact opposing surfaces of the mobile device to limit rotational movement of the card reader body about an axis of the connection device when the card reader body is connected to the mobile device via the connection device.

3. The card reader of claim 2, wherein the card reader body comprises a front and an opposing back spaced from the front,
the connection device is proximate to the front of the card reader body, and
the first arm and the second arm are spaced from the connection device and proximate to the back of the card reader body to limit the rotational movement of the card reader body about an axis of the connection device.

4. The card reader of claim 1, wherein,
the first arm and the second arm each further comprise a guide element disposed on respective arm inner surfaces and proximate to respective distal ends of the arms, and
portions of the first arm and the second arm are configured to flex when the guide elements contact the mobile device during installation of the card reader body to the mobile device and removal of the card reader body from the mobile device.

5. The card reader of claim 4, wherein each guide element comprises a first tapered surface to facilitate connection of the card reader body to the mobile device.

6. The card reader of claim 5, wherein at least one of the guide elements is configured to be received by a recess on a surface of the mobile device.

7. The card reader of claim 6, wherein each guide element comprises a second tapered surface to facilitate removal of the at least one guide element from the recess during removal of the card reader body from the mobile device.

8. The card reader of claim 1, wherein the information reader is a magnetic card reader.

9. The card reader of claim 1, wherein the information reader is an EMV reader.

10. The card reader of claim 1, wherein the information reading area comprises both a magnetic card reader and an EMV reader.

11. The card reader of claim 1, wherein the information reading area comprises a contactless reader.

12. The card reader of claim 1, further comprising another information reading area, wherein each information reading area comprises a different type of reader.

13. A card reader for use with a mobile device configured to receive and transmit information, comprising:
a card reader body having one or more information reading areas configured to receive a card having card information stored thereon;
one or more connection devices configured to connect the card reader body to the mobile device and transmit the card information to the mobile device;
one or more stability arms coupled to and extending from the card reader body and configured to contact the mobile device and limit movement of the card reader body with respect to the mobile device.

14. The card reader of claim 13, wherein the one or more stability arms is configured to limit rotational movement of the card reader body about an axis of the connection device.

15. The card reader of claim 13, wherein the one or more stability arms are removably coupled to the card reader body.

16. The card reader of claim 13, wherein the one or more stability arms are movable along one or more surfaces of the card reader body.

17. The card reader of claim 13, wherein the one or more stability arms comprise a pair of opposing stability arms, each stability arm extending from an opposing side of the card reader body and configured to contact an opposing side of the mobile device.

18. The card reader of claim 17, wherein the pair of opposing stability arms each comprise a guide element disposed on respective stability arm inner surfaces and
portions of the opposing stability arms are configured to flex when the guide elements contact the mobile device during installation of the card reader body to the mobile device and removal of the card reader body from the mobile device.

19. The card reader of claim 18, wherein each guide element has a tapered surface to facilitate installation of the card reader body on the mobile device.

20. The card reader of claim 18, wherein each guide element has a second tapered surface to facilitate removal of the card reader body from the mobile device.

21. The card reader of claim 18, wherein the one or more stability arms comprise a plurality of stability arms extending from a first side of the card reader body and a plurality of opposing stability arms extending from an opposing side of the card reader body.

22. The card reader of claim 12, wherein card readers may include a single stability arm extending from the card reader body.
